(19) United States
(12) Patent Application Publication
(10) Pub. No.: US 2026/0216927 A1
(43) Pub. Date: Jul. 30, 2026

(54) TOOL DESIGN METHODS AND APPARATUS

(71) Applicant: KELVIN CONRAD DOYLE, UXBRIDGE (GB)

(72) Inventor: KELVIN CONRAD DOYLE, UXBRIDGE (GB)

(21) Appl. No.: 19/149,799

(22) PCT Filed: Feb. 26, 2024
(86) PCT No.: PCT/GB2024/000009

§ 371 Date: Jul. 21, 2025

(30) Foreign Application Priority Data
Mar. 8, 2023 (GB) 2303412.7

(51) Int. Cl. B29C 33/48; B29C 70/32; B29K 105/08; B29K 307/04

(52) U.S. Cl. CPC B29C 33/48; B29C 70/32; B29K 2105/0845; B29K 2307/04

(57) ABSTRACT

A tooling design that allows structures or components to be produced in a “one shot” process where secondary processes are limited or reduced to a minimum and where automated processes can be utilised so as to reduce the inaccuracies associated with manual production and in turn reduce the cost of said production. The tool consist of two sections which contain buttresses (9) and flanges (14), where the buttresses fit within the flanges. This design produces a structure and or component with two internal superstructures that are perpendicular to each other and forms a superstructure that can run the whole length of the final structure. Secondary processes can be applied if the structure is modified to act as a mould. The finished structure or component can be joined, if required to other completed structures or components thus increasing the size beyond that of the initial structure, whether it is a wind turbine blade or other large structures.

This Patent Application is for the Design for the tooling regarding the production of any large structure or components; for clarity I use the term Structures and Components, Structures as defined in this Patent are large structures such as caissons, wind turbine blades, fuselage and wings for aircrafts, whole body shells for cars and other motor vehicles.

Components are defined such as components for cars, aircraft, trains but not limited too.

In addition, structures such as nacelle, nose cones for trains and aircrafts etc., as well as residential, commercial and industrial buildings of various types such as factories, dams, silos, and the like whereas components are defined generally for parts for vehicles, planes, trains etc. but not limited too, where these structures and components can be interconnected in sections (if required).

Substructures are the internal structure of the individual tools which are known as buttresses/flanges in this Patent and are defined as structures within the tool or within the final component and or final structure, so that the final component and or structure produced from the tool has the structural integrity required for specific final application. When the internal substructures of the tool forming the final component or structure are interconnected, they form an internal superstructure or “cross section” for the final component or structure. This internal superstructure can be interconnected with the internal superstructure of an adjoining structure and or component as shown in this Patent.

Please also note, I mention internal flanges and internal buttresses, the internal flanges are the section of the internal structure of the tool where the buttresses fit within the flanges of internal structure of the tool and also the horizonal and or vertical internal structure of each section of the tool, the horizontal structure is connected to the external section of the respective tool, whereas the buttress is connected to the horizontals structure where the buttress is at right angles to the horizontal buttress. Please note that the flanges are also connected to the horizontal buttress with one flange able to move towards the other opposite flange so as to compress the buttress that will enter and fit within the flanges from the incoming tool. (I also use the term horizontal and vertical to signify the orientations of the internal structures in the drawings)., There is one buttress on each tool section and two flanges in each tool section, unless otherwise stated as below. The buttresses, the horizontal buttresses, the female flanges are all part of each individual tool sections that come together to form the final structure and or component.

Please note the final structure or component formed by the tool, does not have any flanges only buttresses, the flanges are only associated with each tool section to form the internal structures or buttresses.

It must also be noted for some applications such as aircraft fuselage, at least one of the “vertical” buttresses would not be required otherwise there would be a vertical structure that runs the whole length of the aircraft cabin, the horizontal buttress (forming the floor pan) will still be required with the “lower” vertical buttress; for both sets of tools forming the final structure in this case the fuselages of an aircraft, all structural integrity will be designed within the final structure and the tool will accordingly take into account the structural requirement.

In respect of the shapes required of the final structure, whether it is conical, cube, globe or otherwise, the tool will be designed for such structures and all structures such as described in Page 1/16 and Page 2/16 and corresponding Pages as described in this Patent, describing the tool, the tool will also be shaped to accommodate the above structures both internally and externally (the outer surface as seen in Page 12/16, FIG. 15 for example) of the said structures mentioned above.

As well as the above, the final structure or component produced by the tool, can be also be utilised as a mould, an example of this utilisation is for the production of caisson, large structures predominantly produced from concrete and steel inserts that act as reinforcements for the concrete, these structures are normally extremely large, expensive to build and time consuming in their production, sometimes taking many years if it is a large reclamation (land reclamation or creation from the sea as an example) project where hundreds if not thousands of these caissons may be required; they are generally utilised for building structures on the sea surface, by dropping the caisson onto the sea bed thus (the caissons) acting as the foundations for buildings structures, Therefore, the issues that are involved in undertaking constructing and moving these gigantic structures, some are 10 stories high or more, is a mammoth task of engineering and design and of course implementation. The design of the tooling in this Patent can produce the final structure that will act as a mould with minor modifications to the tooling, will be able to create these caissons in weeks rather than months and years at a considerably lower cost. In addition, due to the lightness of the mould that is produced from carbon fibre, they can be airlifted or produced on quayside and taken out to sea and dropped into situ, concrete can then be poured into the mould, please note the reinforcements of the concrete as seen in this patent, is by way of carbon fibre poles/solid tubes but not limited too. To overcome the issues of spillage of the concrete while being poured into the mould offshore, a fabric collar is placed around the outer surface of the mould neck, this collar is tight enough to ensure that no concrete can overflow into the sea, the collar surface is floated on the sea surface by pontoons that are high enough to ensure that the concrete can be poured into the mould without spillage, please see Page 8/16 that show a heavy dark line FIG. 5, no 42 depicting where the collar of fabric can be placed around the top of the mould, this is an arbitrary placing, the final placement will be on final design and engineering requirements. The collar is removable and reusables. Please note, the mould shown in Page 8/16 is depicted by a square shape, but the shape of the mould can be round (circular) or rectangular or whatever shape the final design requires.

The material to produce the structures or components in this Patent is based on a woven material so as to be wrapped around both sections of the tool either manually or mechanically, the material has to cover all external surfaces of both sections of the independent tool sections. The preferred material is a carbon fibre weave or tape for strength and lightness, but it is not limited to this material, the material can be of any woven structure or indeed or any other suitable material that the final design may require. It must also be noted for the component to be formed, the material is wrapped around the tool in its entirety apart from where the material is not required with regard to the tooling mentioned in this Patent and with regard to final structure or component.

There are numerous methods that can be utilised to form the final structure or component once the two sections are compressed together, (assuming the material is carbon fibre composite) such as compression tooling, vacuum bagging, liquid transfer moulding etc. which can be utilised for forming of the structure and or component by use of this Patent tooling. For example, if utilising a compression method, there will be an external component that will fit around the entirety of the both tool sections to compress them (the tool sections) together and the material within the outer surface of the tool (and all other parts of the tool section which require material coverage as seen in Page 4/16 and Page 7/12).

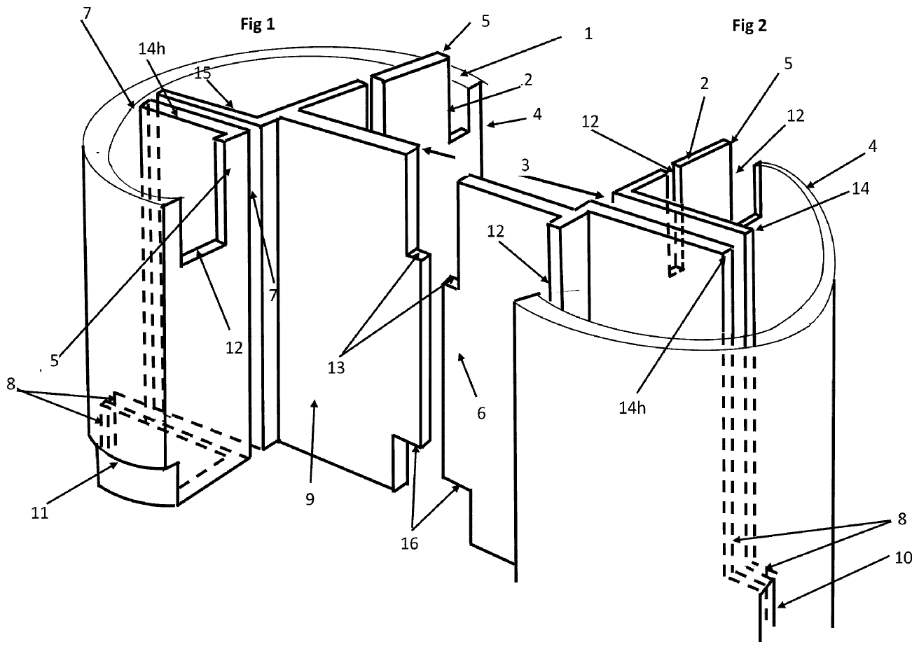

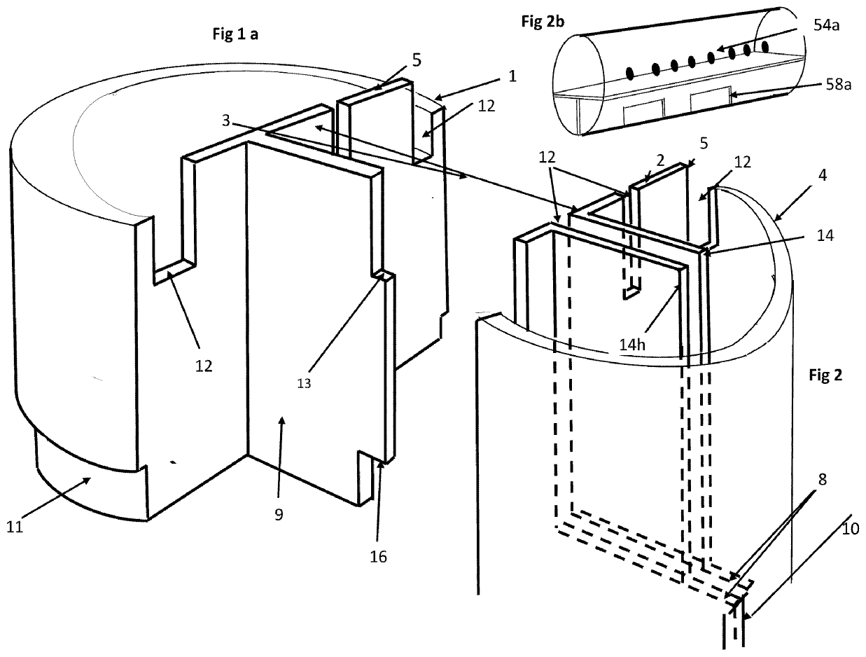

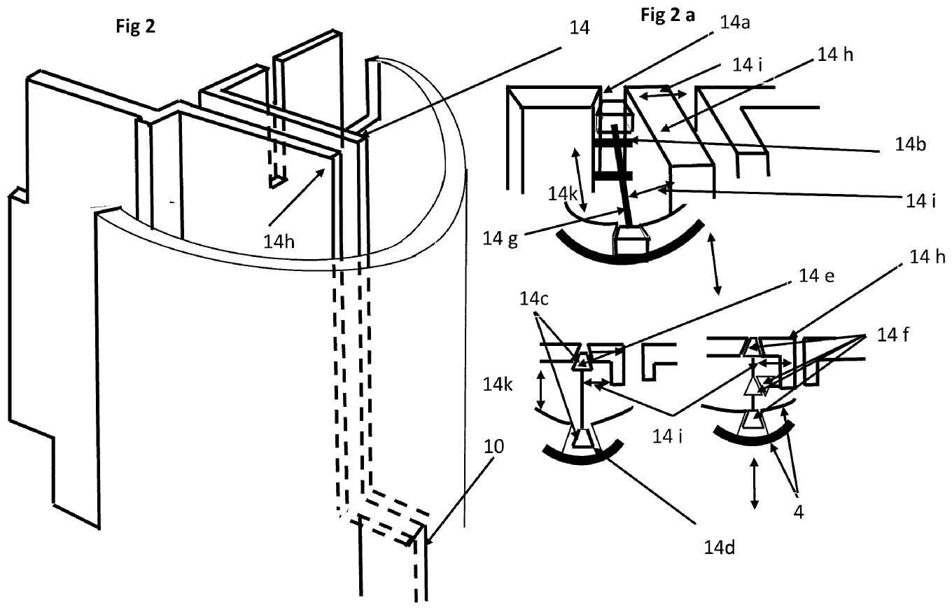

It must be noted that there are two compression processes, it can be called for ease of reference Process 1, where the two tools sections and as seen in this Patent and in particular Page1/16, FIG. 1 and FIG. 2. are compressed together by an outer compression instrument as seen in Page 10/16, FIG. 13b, please note the same type of methodology of FIG. 13b, is also utilised for the compressing the outer “skin” that is wrapped around the final structure or component produced by Process 1, this outer “skin” compression I call Process 2.

On Page 12/16 and Page 13/16 the outer material “sleeve/skin” can also be seen when compressed and cured (if the material requires curing) by the inner surface of the compressions instrument as seen in Page 10/16, FIG. 13b, where the material or “sleeve/skin” is sandwiched between the inner surface of the compression instrument and the outer surface of the final structure or component, this is Process 2 and as mentioned above, is an example of the compression instrument is shown on Page 10/16, FIG. 13b, no. 44a, other processes may be utilised to achieve the same result as above.

Please note; Process 1 in addition to combining the two tool sections together, also in doing so, compresses the material that surrounds the tool where required, an example of this is shown on Page 4/16 and Page 7/16, no. 24 (the material covering the tool). Once the material is compressed the tool is removed; the design of the tool is such that can it can be removed either is one process where each separate tool section as seen in Page 1/16, FIG. 1 and FIG. 2 tool is divided and removed in the direction as seen in Page 4/16, no 26, where the arrows show the direction of travel. It must be noted that the tool is shown in the vertical direction, but dependent on requirements the tool orientation could be in the vertical, horizontal or any degree of orientation required. When I refer to the “tool” (unless otherwise mentioned) I am referring to both sections of the tool, as seen in this Patent and the fact that the tool is removed once the structure or component is produced by said tool, leaving each half of the structure or component joined together by the coming together of the two halves of the tool, (these two halves can be seen in FIG. 1 and FIG. 2), forming the final structure or component as shown in this Patent.

The tool allows the creation of the buttress structures in the final structure or component, where both horizontal and vertical buttress allow large and small structures or indeed components to be joined to together without any localised stress point that may cause failure in the structure at these joints.

The tooling has been designed to create by the said tooling, structures or components where there are no or limited secondary processes that allow structures or components to be built in a “one shot process” (by this I mean a singular process or as few as processes as possible) by ensuring that these structures and components produced by the tool, has internal structures that act as the structural part of the final structure or final component and therefore secondary process do not have to be undertaken to create internal structures that reinforce the component where these internal structures form the superstructure (“cross section”) of the final structure and or component.

Large structures such as wind turbine blades are complicated and expensive to produce and are not always effective where there can be localised stress points, possible bonding of material issues (delamination for example) and structural integrity issues and a number of others such as compression issues and flexing issues where this Patent design can eradicate these problems or minimise and therefore optimising the blade design and construction.

To overcome many of these issues a “one stop process” (minor additional processes are required if the tooling is utilised as a mould) is, I believe, the best possible route to ensuring the integrity of the structure and or component. By creating a “one stop” process or reducing the processes to as few as steps as possible, as mentioned, will overcome many of these structural issues and more importantly reduce cost in some cases dramatically, which is as an important factor as structural integrity.

In addition, the tooling designed show how these internal structures can be formed and interconnected where, as mentioned above, the interconnections joins are seamless and are integrated and formed by the two sections of the tooling coming together and forming the structure and or component after the material has been formed around each tool. Each structure and or component can be part of a section (if production in sections are required) of a structure and or component and can be interconnected without having to add secondary processes to produce these internal superstructures (cross sections), the connections between section have to be either bonded (if the component or structure does not need to be separated) or connected by other means such as bolts or rivets or other joining methods if needed to be removed from each other.

The Main Structure as described in the Description referred to above and the Abstract below, consists of a two sets of tools that mirror image of each other apart from the fact that the buttresses or internal substructure are “off Set” against the oppositive section of the tools buttress or internal structure. In addition, the Flanges, the internal structure is offset against the opposite tool internal Flanges so as not to impinge on the incoming tool section when both sections of the tool are placed together. The description of the tooling can be seen in the following:

Page 8/16 to Page 15/16, Including Page 3/16 show either the full structure and or component made from the tool or part sections, these part sections show how the final structure and or components are produced and or how they are joined together by the superstructure (which is formed by the tooling) to form larger structure and or components or sections of a larger structure and or component, Page 1/16, Page 2/16, Page 4/16, Page 5/16 and Page 7/16 shows the tooling, this tooling makes the structures and or components. Page 6/16, FIG. 5, to Page 8/16, FIG. 5, shows how the tool can be shaped as a square or rectangle and can come together to form a square or rectangular structure, thus producing the final structure and or component after each individual segment (segments for example are shown in Page 1/16, FIG. 1 and FIG. 2) of the tool is covered in the appropriate material and are joined (the two tool sections) together.

Page 4/16, FIG. 1 and Page 7/16, FIG. 7, shows how the material, in this case carbon fibre, covers the outer surfaces of the structure (for illustrative purposes only part of the material cover is shown on the tool).

Page 2/16 FIG. 2b, where a section of the finished structure can be seen, as it can be seen on Page 3/16, Page 9/16, Page 10/16, Page 11/16, Page 12/16, Page 13/16 (view looking straight down the structure or component), Page 14/16, and Page 15/16 (please note these pages show the cylindrical structure). In Page 2/16, FIG. 2b, shows a section of a fuselage of an aircraft, as an example, where the top vertical buttress as can be seen in the finished structure or component on Page 11/16 no's 56 and no. 58 and on the above pages, (apart from Page 14/16, FIG. 17 which does not show either the vertical buttresses above or below the horizontal buttresses,) is not required so that there is an unobstructed clear area within the passenger compartment of the fuselage, the lower buttress as seen on Page 9/16, FIG. 13, Page 10/16, FIG. 13b, Page 11/16, FIG. 14, Page 12/16, FIG. 15 (component shown in the vertical direction) and Page 13/16, FIG. 16 remains and can be designed by cutaways as shown in no Page 2/16, 58a to incorporate the internal requirements of the aircraft such as the undercarriage, electronics, cargo etc. and no. 54a the portholes shown represent the window of the passenger compartment or fuselage, both no. 54a and 58a are for illustrative purposes only.

Page 2/16, Shows FIG. 1a and shows FIG. 2b, where FIG. 1a is the same tool section of Page 1/16, FIG. 1 apart from the fact that no Flanges are shown in tool FIG. 1a. In Page 2/16, FIG. 2b shows there is no requirement for the lower vertical buttress as shown in Page 1/16, FIG. 2, no. 9, (assuming no. 9 is the vertical buttress), if no. 9 is the vertical buttress then the tool sections when combined will be rotated to horizontal orientation by rotating left in this case, or rotated right to be in the horizontal orientation then the vertical buttress which will not be required is no 6, otherwise the design of the tool section is same as that of Page 1/16 FIG. 2.

Page 8/16, FIG. 5 is different to the above, because this shows how the same design, slightly modified by the cutaways shown FIG. 5, no. 37a, which allows the Dividers FIG. 9, no 36, to fit within the component FIG. 5, no. 31 in the Complete structure FIG. 5, forming the superstructure or “Cross joint” as shown in FIG. 9 no. 34, placed within FIG. 10 where this tool creates the structure that can acts as a mould for concrete for the production of caissons or other large structures but not limited to such large structures, in the case of caissons the mould will not be removed from the concrete and will remain in situ and also forms reinforcement and protects the concrete.

Page 8/16 that show a heavy dark line, FIG. 5, no. 42, depicting where the collar of fabric can be placed around the top of the mould.

Page 1/16, FIG. 1, no. 3 shows double headed arrows showing the direction of travel of the two sections of the tool, showing how they fit together to produce the structure or components, where the two horizontal buttresses (to save confusion the horizontal buttress structure spans the whole diameter of each individual tool section and is an integral part of each tool section) shown in Page 1/16, FIG. 1, no. 5, moved towards each other by suitable external means as mentioned in this Patent, hence sandwiching the material placed on the tool as shown on Page 4/16, FIG. 1, no 24 and also seen on Page 7/16, no 24, showing part of he tool covered by the material (in this case carbon fibre weave) on the surfaces of the horizontal buttresses facing each other.

The material is compressed by the coming together of both tools sections where the horizontal buttress and vertical buttresses are covered by the material, hence covering the total surface area of each tool section in their entirety where necessarily required, to ensure when the tool sections FIG. 1 and FIG. 2 come together they, the tool sections, are able to form the final structure and or component.

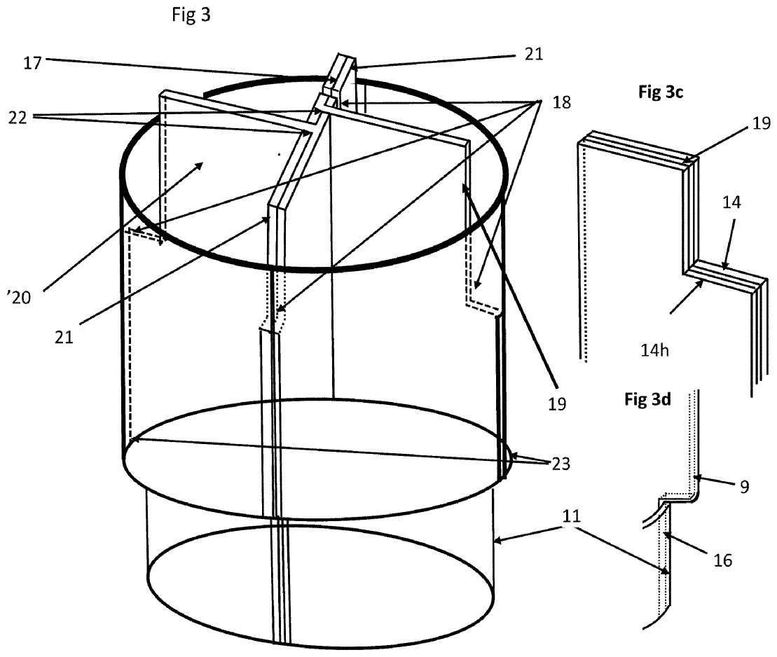

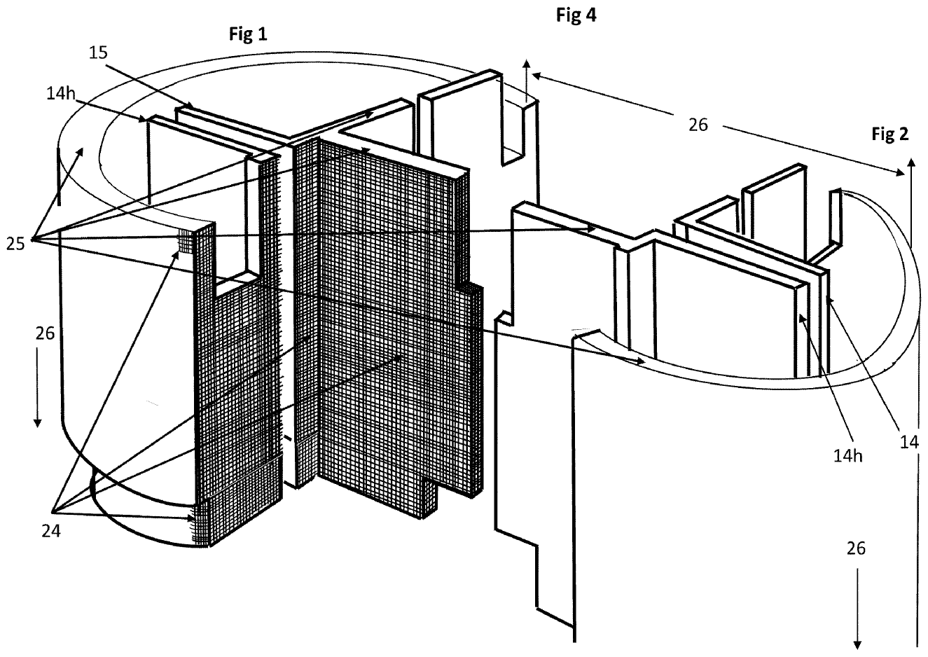

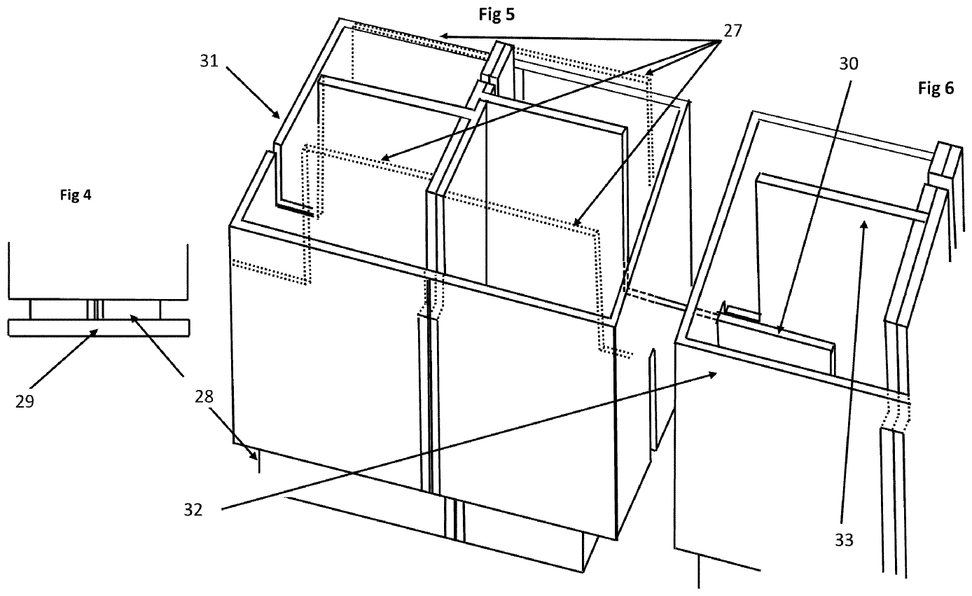

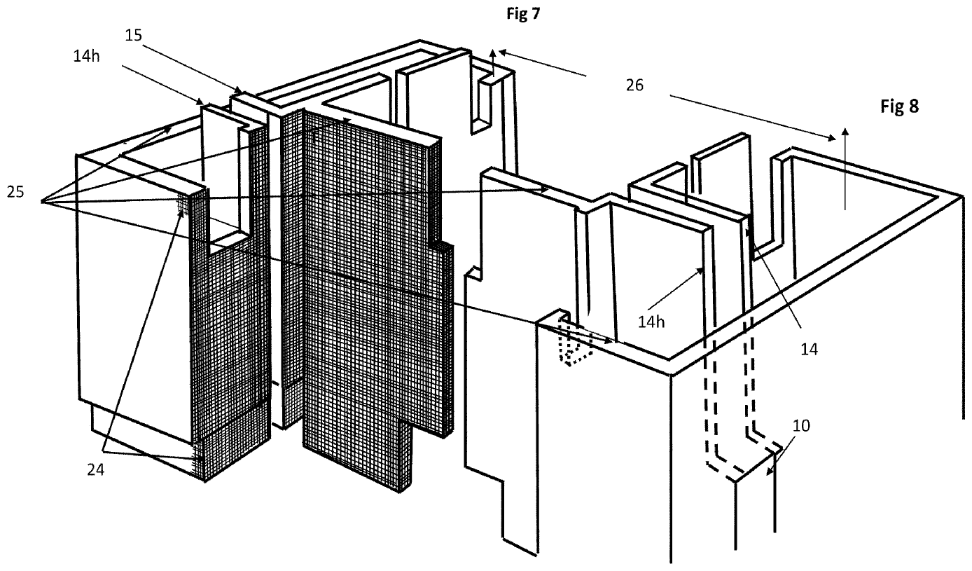

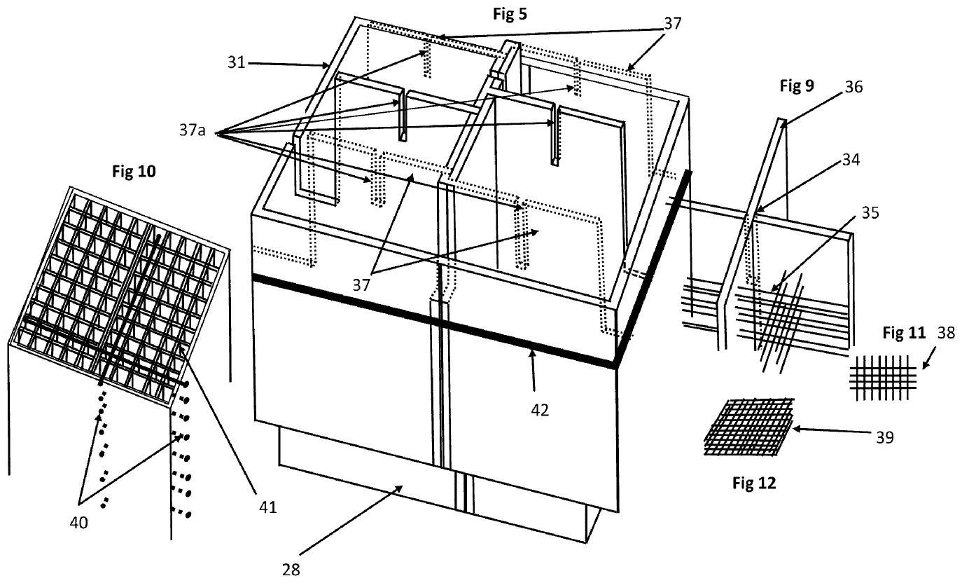

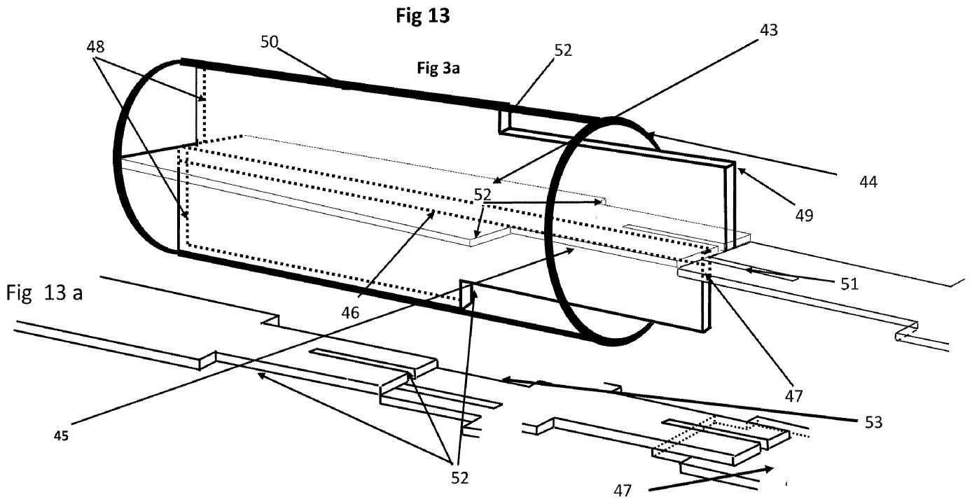

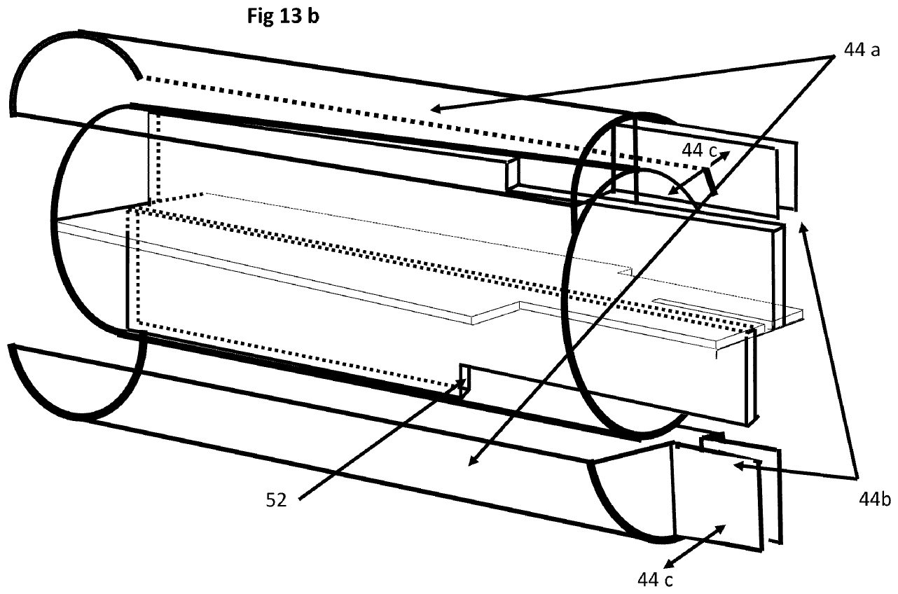

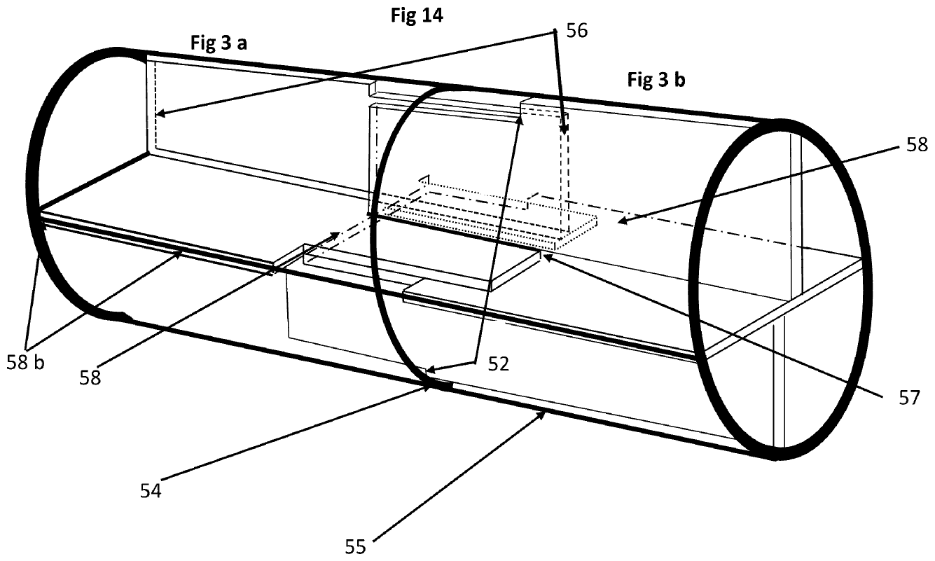

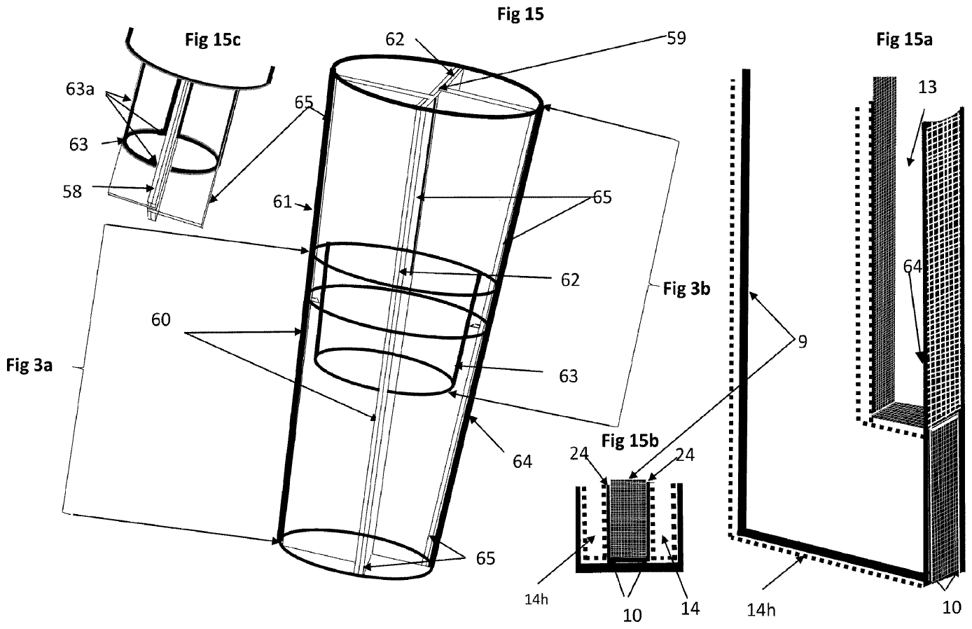

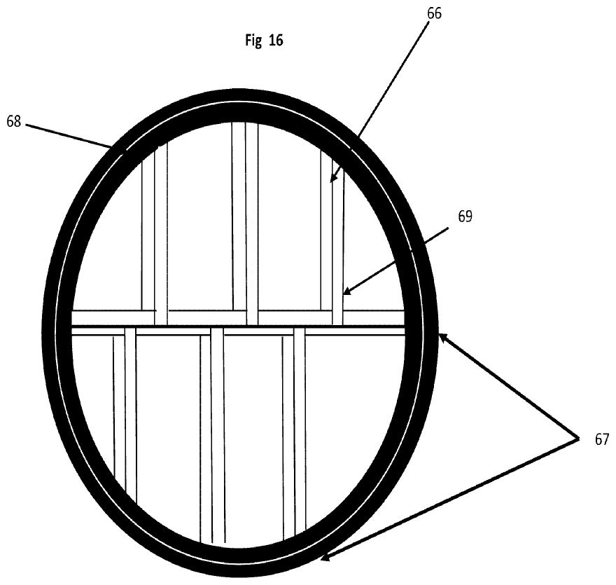

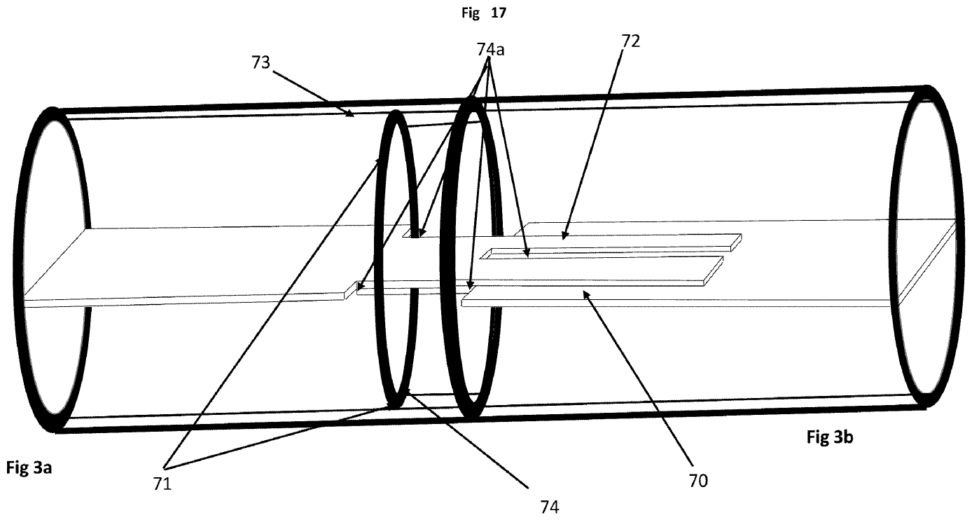

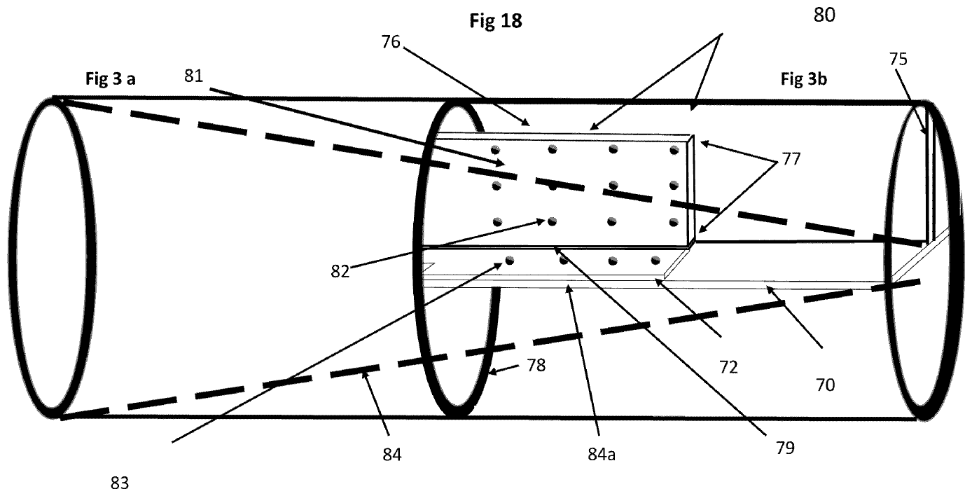

Page 1, FIG. 1, no. 1 and FIG. 2, shows two halves of the tool to make the structure and or components, no. 2 showing the extended lip or buttress as per Page 9/16, FIG. 13 no. 49, also as seen in FIG. 13, no. 49 shows that the buttress corners are at right angle, this is only for illustrative purposes, this edge as in all the edges, can be either right angled or curved (rounded) at whatever degree the final structure and or component produced from the tool as shown in Page 3/16, FIG. 3, Page 9/16, Page 10/16, Page 11/16, Page 12/16, Page 13/16 and Page 15/16, (please note Page 15/16, lower vertical buttress not shown) is required. As shown in the Pages 3/16 and on Pages 10/16 to Page 15/16 (apart from Page 14/16,) there are two sections joined together forming a final structure or component; in these drawings of the final structure or component is shown to be a cylinder, however the tool can be conical, square, ellipsoid, a globe, etc. therefore the internal structures both horizontal and vertical forming a cross section shown in this Patent and in particular Page 9/16 to Page 15/16 (please note Page 15/16, FIG. 18, does not show the lower vertical buttress) apart from Page 14/16, and the tool that produces these sections and the final shape of the final structure and or component (tool shown in Page 1/16), will correspondingly then be shaped/designed and compensate to produce any of those above mentioned shapes as shown in the heavy broken line of Page 15/16, FIG. 18, no. 84, which shows clearly that shape of the structure and or component being that of a cone and this being the case both the internals buttresses and the flanges of each tool will also taper so as to form the conical shape, this will also be true too for the above mentioned shapes of a globe or a cube or a cylinder etc. Please note Page 1/16, base of FIG. 2 not shown. Page 1/16, FIG. 1 no. 9 section (buttress) fits within FIG. 2, no. 14, (where no. 14 is also part of and perpendicular to the horizontal buttress) of the flange, travelling within the flanges FIG. 2 no. 14 and no. 14h. and where no. 6 buttress fits within the flanges of FIG. 1, no.15 and 14h (where no. 14h is the movable flange), where these two sets of flanges of no 14/no. 14h and no. 15/no. 14h, are part of the horizontal buttresses FIG. 1, and FIG. 2 no. 5 (flange no 14h is connected to the horizontal buttress as shown on Page 5/16, FIG. 2a) and perpendicular to the horizontal buttresses. In addition, it can be seen that on Page 1/16 no 6 and no 9 and as can be seen clearly in Page 3/16 FIG. 3, no. 22, the buttresses are perpendicular to their corresponding horizontal buttresses and are also a part of the horizonal buttresses.

Page 1/16, FIG. 1, no 16 shows the cutaway in buttress no. 9, to allow this incoming buttress no. 9 to fit within the opposite tool FIG. 2, so as to allow buttress no. 9 fit over the incoming male sections shown on no. 11, in this case FIG. 2. This is the same for buttress no. 6 allowing buttress no. 6 to fit over the male section no. 11 of FIG. 1. This can be seen clearly in isolation on Page 3/16, FIG. 3d. Male section no 11 is not shown in Page 1/16, FIG. 2, but can be seen clearly on Pag 3/16, FIG. 3, of the finished structure or component produced by the two halves of the tool (FIG. 1 and FIG. 2) coming together.

Page 1/16 FIG. 1 no. 12, cutaway to allow the male section of the incoming tool as shown in Page 12/16. FIG. 15, section FIG. 3b no. 63, to enter the female section of Page 12/16 FIG. 15, Section FIG. 3a.

The internal structure, Page1/16 FIG. 1 no. 15/no.14h and the no .14/no.14h where they show the flanges to accommodate the buttresses of no. 6 and no. 9. Page 3/16, FIG. 3, no. 19 and no. 20 show the vertical buttress of the finished structure and or component, The horizontal buttresses on Page 3/16 is depicted by no 17, no 17 of FIG. 1, where buttress no. 9 is part of, shows the internal buttresses of the final structure or component joined together forming a bridge between the two components formed by the tool, when the tools (as seen in Page 1/16, FIG. 1 and FIG. 2) are placed together to form the final structure or component.

Page 3/16, FIG. 3, no 21 shows the internal horizontal buttresses of FIG. 2, (where buttress FIG. 2, no.6 is part of), of the finished structure or component.

Page 3/16 also shows the finished component as does Page 6/16, Page 8/16 and Pages 9/16 to Page 15/16 (Page 14/16 only shows the horizontal buttresses where in some case the vertical buttresses may not be required). The buttresses of tool section FIG. 1, create the structural part of the final structure or component, allowing the buttress of Page 1/16, FIG. 1 no. 9 and FIG. 2 no.6 to slide between the respective two female flange forming a fit that allow the material that cover the buttresses of no 6 and no. 9, to be tightly compressed against the inner walls of the female flanges of no. 15 and no. 14 where flanges no. 14h are movable so as to compress the buttresses, once the buttress no. 6 and no. 9 traverses the whole depth of their corresponding flange no. 15/no.14h and no.14/no. 14h respectively and the tools FIG. 1 and FIG. 2 are connected together forming the final structure and or component.

Therefore, the final structure and or component has the final internal superstructure formed by the tool sections without any secondary processes required to produce these internal structures.

Page 3/16, FIG. 3, no. 19 and no. 20 shows how the vertical buttress Page 1/16, FIG. 1, no. 9 and no. 6, respectively, connect to the structure FIG. 1, no. 4 and are part of the internal structure of the finished structure and or component. In addition, the internal structure is also part of the horizontal buttresses. structure FIG. 1, no. 5.

Page 1/16 FIG. 1 and FIG. 2 shows how the buttresses no 9 and no 6 fit within the flanges of no. 14 and no. 14h and no. 15, no. 14h respectively, where Page 1/16 FIG. 2, no. 6 fits inside the flange FIG. 1, no. 15 and no. 14h which will be shown to be on either side of buttress of FIG. 2 no. 6. and where FIG. 1, no. 9 fits within the flanges no. 14 and no. 14h which will be on either side of buttress of FIG. 2 no. 9. It must be noted that what is shown in Page 3/16 is the finished component. However, the terminology of Buttresses remain the same, whether it is for the tool or the final structure and or component. Please note the final structure or component will not have the Flanges which are only part of the tool and is only related to the tool sections or when the tool come together to form the final structure or component.

Page 3/16, FIG. 3, no. 17, also shows the two horizontal buttresses joined together, joining the two independent tooling structures of Page 1/16, FIG. 1 and FIG. 2 and Page 2/16, FIG. 1a and FIG. 2b to form the final structure or component as shown in Page 3/16, Page 6/16 and Page 8/16 FIG. 5 as also shown in Page 9/16, FIG. 13, Page 10/16. FIG. 13b Page 11/16, FIG. 14, Page 12/16, FIG. 15 and FIG. 15c, Page 13/16 FIG. 16, Page 14/16, FIG. 17 and Page 15/16, FIG. 18. Page 3/16, FIG. 3, no.18 shows the cutaways in the horizontal and vertical buttresses shown in Page 1/16, FIG. 1 and FIG. 2, no. 12, where in FIG. 3, no 18 shows the cutaways once the two sections of the tool are joined together to form the final structure or component (as seen in FIG. 3).

Page 3/16 FIG. 3, no. 23 where buttresses meet the external structure of the final finished structure or component formed by the tool (the opposite meeting of the buttress and the internal structure of the finished structure or component is not shown) and also shown on Page 8/16, to Page 15/16, except Page 14/16, where only the horizontal buttress is shown.

Page 1/16, FIG. 1, no.12 show cutaways to allow male section of a secondary structure as seen in Page 1/16, FIG. 1, no. 11 (the male section), and also seen on Page 12/16, FIG. 15, no. 63, and on Page 14/16, FIG. 17, no. 71, allowing a secondary structure to enter the female section of the primary structure; for this Patent the primary and secondary structures are defined as section FIG. 3a (primary structure) and section FIG. 3b (secondary structure). These cutaways allow the horizontal substructure or buttress to enter the secondary structure or component to allow the finished structure or component to join and connect these structures or components. These cutaways can be also seen clearly on Pages 2/16 to Page 15/16, (apart from Page 13/16), and where on Page 12/16, FIG. 15a, no. 13 and Page 14/16, FIG. 17, no. 74 where in Page 14/16 there is no vertical buttress is shown.

For clarity the cutaways (not to scale) accommodate the incoming male section of any secondary structure and or component where the secondary structure or component can be seen on Page 12/16, FIG. 3b, no. 63 where FIG. 3b is a secondary structure that can also be seen on Page 11/16 and Page 14/16, FIG. 17 no. 71.

Page 4/16, FIG. 4, no. 26, the arrows show the directions (vertical) of travel of the tool on removal from final structure and or component, final method of removal will be decided on final design of the tooling.

Page 4/16, FIG. 4, no. 25 The top edges/surfaces are not to be covered so that the tool can be removed from the component; the tool will be moved in the vertical direction away from the structure and or component if the structure and or component is vertical, or in the horizontal direction away from the structure and or component, if the structure and or component is horizontal, or in any other degree from the Vertical or Horizontal. It must be noted, dependent on the final design of the tool, the tool may be removed by other methods.

Page 4/16, FIG. 4, no. 24, shows how the outer surface areas are to be covered by either a woven material or other suitable material. All outer surfaces are to be covered, apart from the open or cutaway areas as shown. Please note in this FIG. 4 no. 24, not all outer surfaces have been covered, the covered surfaces showing only a proportion of outer surface area covered, this is purely for illustrative purposes, to show the fact that the open area and cutaway areas are not to be covered. Both sections of the tool outer surfaces will also be covered in the same manner. Please note that if for structural reasons, the buttresses and the required surfaces can be covered in a more structurally robust material such as carbon fibre and then the final outer skin/sleeve could be covered in a lower cost material such as glass fibre or even high strength canvas, it must be noted in some cases the outer skin/sleeve will not be needed because a single section such as FIG. 3a, may represent a completed structure or component that will not be needed to be attached to any other secondary structure and or component. It may be noted that the sleeve/skin may not also be needed if a number of sections are interconnected, it will be entirely dependent on the final design requirements.

Page 5/16 FIG. 2a shows how, if required, the buttress, can be designed where the flanges (only one is required to move) can be moved in a Perpendicular/90 degrees to the incoming buttresses shown in Page 1/16, FIG. 1 and FIG. 2, no. 9 and no. 6 respectively, this allows the whole flange to compress against the incoming buttress no 6 and no. 9. The flange Page 5/16, FIG. 2a no. 14h can be connected by “pistons” as can be seen by no 14b, these pistons connect the main body of the tool as can be seen FIG. 2a. to the moveable flange no. 14h in FIG. 2a. The Bolsters seen in no 14c are connected by a bar (or appropriate systems) as shown in no. 14g the Bolsters move in both directions of travel towards and away from the tool, no. 14e shows the Bolsters in the open position as is the horizontal flanges and no. 14f shows the bolsters in the closed position as is the horizontal flanges when closed as in no. 14f. No 14d shows the bolsters in the open position within the outer tool section, the outer tool sections can be seen on Page 1/16, FIG. 1 and FIG. 2 no 4, Page 2/16, FIG. 2, no. 4 for example. The outer tool section can be shown in a magnified view on Page 5/16, FIG. 2a and also shows the bolster within the outer tool section as shown in Page 1/16, FIG. 1 and FIG. 2, no.4 (the outer tool section). When the bolsters are closed it (the flange 14h) travel the required distance towards flange 14 and flange 15, the double headed arrow shown in Page 5/16, FIG. 2a, no 14i shows the direction of travel where the flange compresses the material (in this case carbon fibre) to the required pressure between the flanges and vertical buttresses, so that the carbon fibre material can be heated and cured and when cured, the flanges can be moved apart by the bolsters when they (bolsters) move to the open position, it must be noted to open and close the buttress, either a ratchet mechanism is designed into the outer tool sections or an high pressure air systems or other methods currently available.

Page 5/16, FIG. 2a, no 14a shows the gap that the bolsters move within; please note the bolsters are within guides (not shown) where the bolsters are under pressure when moving to their closed position by suitable mechanisms within the guides. The bolster (not shown) are pushed open as seen in Page 5/16, FIG. 2a, no. 14c and will remain in the open position until such time they are forced to the closed position by suitable mechanism's such as ratchets or high pressure air system that an integral part of the outer wall of the tool. It can be noted the Flange can be seen in part in Page 5/16, FIG. 2a, no 14h. no. 14k show the two headed arrow that depicts both direction of travel of the Bolsters from open to closed position and visa versa. FIG. 2a, no. 4 shows the tool outer wall as seen in Page 1/16, FIG. 1 and FIG. 2 no. 4.

It must be noted that the mechanism shown in Page 5/16, FIG. 2a, are shown for illustrative purposes so that the reader can see how the mechanism to move Flange 14h works, In the final design these mechanisms will be hidden from plan view and from side view, and will not impinge on the covering of the tool with the required material where necessary. Please note, the connecting bars between the buttress will be able to be seen, it must also be noted these connecting bars can be split so as to remove the tool when the finished structure or component. As mentioned previously the movement of the Flange 14h may deployed by other suitable means which will be incorporated in the final tool design.

Page 8/16, FIG. 5 shows the structure produced by the tooling for the possible building of structures such as rapidly produced low cost housing or warehousing or indeed hospitals; there is a great need for cheap, rapid affordable housing in the UK and globally the main structure of the building can be produced in a one shot process. If housing or hospitals etc., all plumbing, electrics can be added in as secondary processes, currently this Patent is looking at a maximum size of the structure (this may change in the future) due to rapid tooling is circa 25 m in height will be dependent on tooling design, however as seen in this Patent the smaller height of each final structure can be bonded together to reach an estimated height of 25 metres height, this would give a total surface area of the floor of 25 m×25 m=625 m and since the height could be to 3 m, the building can be split level, giving a ceiling height of 3 m (or greater or less if required). If utilised for housing, each level (in the vertical direction) can be easily divided into 625 square feet apartments, easily accommodating a family of four comfortably, allowing ten apartments, on each floor; 8 floors in total of circa 3 m in height. This would mean that each structure can accommodate 40 people per floor, accommodating, 320 people per structure. 10 structures would accommodate 3,200 people, or 100 structures would accommodate 32,000 people, enough to give immediate accommodation in a disaster zone such as earthquake or flooding or any other disaster zones. They can be produced in hours and shipped if they are made in 25 m height, or airlifted if they are produced in 9 metre height anywhere in the world if assistance is needed. Since the tool can be made in any size up to 25 metres as mentioned this tool size may well increase, the width of the tool and height of the tool can be produced to construct the finished structure (in this case housing) so that the finished structure could fit within a rapid mode of transport such as aircrafts.

These can be semi-permanent structures or permanent structures, if permanent structures, they can be clad on the outside to fit the natural surrounding (please note the carbon fibre has to be clad on the outside and inside to protect and insulate the building/structure), therefore to fit the natural surroundings as mentioned above, the structure can be clad in wood if in a country where homes are predominantly built from wood as an example.

Where required, doors and window cutaways can be introduced where necessary, the floorspace can be divided by removable walls so as to make the rooms as large or as small as required. In case of housing, relatively small spaces are required, whereas in the case of warehousing or hospitals, larger open spaces may be required Since all structures can be interlocked where necessary, both in the vertical and or horizontal direction they can produce tall buildings rapidly and at low cost in particular in regions where the buildings are prone to earthquakes or where building are not built to high level of structural integrity leading to skyscraper or tall building collapse.

Page 8/16, FIG. 5, no. 37 show further possible buttresses and also no. 37a shows the cutaway. The additional buttresses may produced by the tool, If required for greater structural integrity/space division.

Page 6/16, FIG. 5 no. 28 Shows the male section, this can be set in a foundation of a corrugated sandwich material FIG. 5, no. 29 (if in an earthquake zone) or other methods where the material or foundation is robust enough to hold the complete structure, but can adsorb further tremors. The whole structure including the corrugated sandwich structural material (or other suitable structure that are technically available) can then be set in concrete or other suitable material.

Page 6/16, FIG. 5, no. 30 shows the extension of this buttresses that can be extended, in this case laterally, so that the buttresses no. 30 can enter the neighboring structure of FIG. 6, no. 32. The buttress of FIG. 5, no. 30 will be connected by suitable means to the buttress of FIG. 6, no. 32 such as described on Page 15/16, FIG. 18, no. 82. Please note that the buttress of FIG. 5, no. 30, is shown to partially enter the neighboring structure Page 6/16, FIG. 6 and traversing part of the buttress shown in FIG. 6, no. 32 showing the complete structure of the neighboring structure, is for illustrative purposes.

Page 6/16, FIG. 5, no.27, shows further possible buttresses, broken lines show possible position of the further buttresses, the unbroken lines depict the buttresses current position.

Page 6/16 FIG. 6, no. 32, complete structure ‘FIG. 6 (partly shown) that can be connected to any other complete structure/structures and or components.

Page 6/16, FIG. 6, no. 33 shows the vertical buttress of the neighboring structure or components, the buttress is seen clearly on Page 3/16, FIG. 3, no. 20.

Page 6/16, FIG. 5, no. 31 complete structure or component shown.

Page 7/16 shows the two sections of the tool one of which (FIG. 7) shows partial outer surfaces covered in material as shown also on Page 4/16 FIG. 1, no. 24.

Page 8/16, FIG. 9 shows a very simple “Cross joint” (not to scale) where the divider FIG. 9, no. 36, crosses the buttress forming a cross shape. Page 8/16 FIG. 9, is shown in isolation showing how the buttresses join. Page 6/16, FIG. 5, no. 27 shows the buttresses before the dividers are placed in. Page 8/16, FIG. 5, no. 37a shows Cutaways of FIG. 1, no. 6 depicting the buttress (the cutaway of no. 37a not shown in Page 1/16, FIG. 1, no. 6) so that the Divider FIG. 9, no. 36 can slide into it; the buttress no. 6, forming the “Cross joint” as shown in Page 8/16, FIG. 9, no.34. The Divider FIG. 9, no. 36, Cross Dividers are not shown. Please note there can be a number of Divider beams (please note the dividers should not be confused with buttresses) placed in the complete structure FIG. 5, no. 31, dependent on the structural strength required or in the case of Caissons, where the whole structure acts as a container/mould for the concrete poured into it. I envisage if for example, the Caisson are of 25 metres by 25 metres base and 25 metres in height, the dividers will form a grid section forming 2.5 m×2.5 m×25 m “Cells”, much like a chess board if looking at it in “Plan view” and where they (the Dividers) are apart by circa 2.5 metres for example (the distance apart is wholly dependent on the structural engineers calculations and requirements) and also the numbers of buttress can be increased so as to take into account the numbers required; to be eight, if circa 2.5 metres apart in this case. The number of dividers and the amount of buttresses required is dependent on the final design and required structural integrity of the final Caisson as mentioned above. The structure FIG. 5, no. 31; Complete structure, FIG. 5 is in the case of Caissons, is used as not only a mould for Caissons but also give the Caissons by having this grid structure, the structural strength and integrity required; the carbon fibre structural strength replacing steel, with all the advantages (which I am not expanding on in this patent because there is enough data available publicly) that carbon fibre brings by replacing it for steel whenever possible.

Page 8/16, FIG. 9 Cross Dividers are shown. FIG. 12, no 39, shows a 3D section of the grid created by carbon fibre composite poles or other suitable material that are placed through the structure Page 8/16, FIG. 5, and in the Complete structure Page 8/16 FIG. 10. FIG. 12 no. 39 (internal sectional 3 D view of FIG. 10) . FIG. 5, no. 41 shows each section (in this case 100 in all) of the columns produced by the dividers within the tool of FIG. 5, FIG. 11 shows a side sectional view, FIG. 11, no. 38 also shows the grid produced by the carbon fibre composite poles or other suitable material as a side view. FIG. 10, no 40 also shows rows of the carbon fibre Poles composite or other suitable material that act in two ways but not limited too:
1) They act as structural strength to the concrete and
2) They connect the concrete pillars, in this example there are 100 concrete pillars all interconnected so that it gives the concrete pillars added structural strength. Each concrete pillar is separate and if one fails it does not affect any other pillar and therefore still keeping the whole structure extremely stable, further advantage is the whole concrete structure is enclosed by the carbon fibre composite structure, therefore protecting the concrete.

Page 8/16, FIG. 9, no 35, also show the carbon fibre composite poles or other suitable material as a sectional view for one of the sections grid, the grid is only displayed by two sides, where the other two sides are shown open for illustrative purposes only.

The holes for the carbon fibre composite or other suitable material, poles can be cut either by laser or water jet cutters or some other suitable means. The holes shall have a reamed fit with the poles and the poles are bonded to the holes by suitable bonding agents if necessary.

The number of carbon fibre composite poles or other suitable material and their respective distribution within the “cells” created by the dividers and the buttresses will be determined by structural engineers and are not part of this Patent. Correspondingly, the thickness of the carbon fibre composite poles or the combination of the materials to make the carbon fibre composite poles or other suitable material is again subject to final structural analysis and design.

Page 9/16, FIG. 13, no. 43, where the buttress is shown in the horizontal position (the structure Page 9/16, FIG. 13, shows the whole structure and or component in the horizontal position).

Page 9/16, FIG. 13, no. 48, the broken line structure shows part of not only the structure or component formed in FIG. 13 but also as seen in Page 10/16, Page 11/16, FIG. 14, no.58, Page 12/16, FIG. 15, no. 59 (no. 59, shows the cross section formed by the horizontal and vertical buttresses) to no. 65, Page 13/16, FIG. 16 no. 66, Page 14/16, FIG. 17, (FIG. 17 does not show the vertical buttress) and Page 15/16, FIG. 18. However these Pages do not show that the component depicting each section of the tool can have the internal structure positioned such that the two vertical and horizontal internal structural buttresses distance of travel within the internal structure (buttresses) of a connecting structure or component for example on Page 11/16, FIG. 14, no 56 and no 58, where it can be seen the distance of travel of the internal buttresses overlapping the internal buttresses of the connected secondary structure or component. Section FIG. 3a connected to Section FIG. 3b where the buttresses overlap the buttresses of the connected Section, in this case FIG. 3a, where FIG. 3a is connected to FIG. 3b, and where no. 80 shows the overlap and connections of the vertical buttresses of Section FIG. 3a and Section FIG. 3b. The distance of the overlap of the buttresses whether vertical or horizontal will be wholly dependent on the structural requirements of the final design of the final structure or component.

The horizontal internal structure where the buttresses are offset from the center shown by broken lines the outer material such as carbon fibre composite has not been shown in Page 9/16 to Page 15/16, but has been represented in part by heavy black lines of the final structure and or component. Please note in the Pages 9/16 to Page 15/16, the structures are described and shown as a cylinder for illustrative purposes, it can be conical or tapered as in turbine blades as such designed to suite the application.

Page 9/16, FIG. 13a, this shows how no. 53 overlaps no. 47, the horizontal buttresses are also shown in Page 14/16, FIG. 17, where section FIG. 3a, no. 72 fits over section FIG. 3b, no. 70.

Page 9/16, FIG. 13a. no. 44 show the outer skin or sleeve.

Page 9/16, FIG. 13a, no. 50 shows the vertical internal buttress flush with the outer skin or sleeve.

Page 1/16, FIG. 2, no. 6 Section (buttress) Fits within FIG. 1, no. 7 the gap that allows the buttress no. 6, to enter into and between the two flanges that are shown in Page 1/16, FIG. 1, no. 15/14h. In addition, the opposite section of FIG. 1, no. 9 buttress fits within FIG. 2, no.14/14h. the two flanges. The flanges as shown in no. 14 and no. 14h and also flanges no. 15 no. 14h where it can be seen that these two buttress sections are off set against each other so as not to impinge on each other as the two halves of the tool combine to make the one single tool, to be able to produce the final structure and or component.

Page 1/16, FIG. 1, no. 8 and also shown in FIG. 2, showing the flange sections by broken lines. Double headed arrows FIG. 1, no. 3 shows how they fit within the respective sections. Please note no. 8 not to be confused with the flange sections shown by FIG. 1, no. 15, no. 14h. they are the same Flanges apart from no. 8 shows the Flanges as broken lines to show the flange profile within both tool sections FIG. 1 and FIG. 2

For clarity it can be seen in isolation on Page 3/16, FIG. 3 c, how the buttress FIG. 3, no 9, (no. 19, in FIG. 3 and FIG. 3c is the same buttress as Fig, no. 9 except it is in situ in the completed component) fits within the flanges FIG. 3c, no. 14 and no.14h, these flanges can be seen on Page 1/16, FIG. 2, no.14 and 14h and Page 2/16, FIG. 2.

Page 1/16, FIG. 2, no. 10, show the gaps where the buttress enters the wall of the tool. As can be seen in Page 13/16, FIG. 16, no 67 the final structure or component, where it can be seen that the inner buttress is flush with the wall of the final structure and or component and the inner surface of the sleeve/skin will be bonded to the outer surface (the inner surface is the surface that is facing the surface of the final structure or component) of the finished structure or component. It must be noted that FIG. 16 shows the final structure and or component that is covered by the sleeve/skin.

Page 1/16, FIG. 1, no. 11 shows the step that can be described as the male section of the tool so as to allow one completed structure and or component that is produced by the tool which has been covered by the required material such as carbon fibre or other suitable material, to fit within a secondary completed structure and or component as shown in Page 12/16 FIG. 15 and where no. 63 shows the male section of Section FIG. 3b, fit within the female Section of FIG. 15 Section FIG. 3a as can also be seen on Page 11/16, Page 12/16. Page; 13/16; FIG. 16 shows a telescope view of the two structures or components when they are joined together. Page 14/16 and Page 15/16 shows the two components bonded together after the final structure and or component emerge from the tool forming the required structure or component to be made; again, the material that produces these structures and or components will be decided by the final design and technical and structural requirements of said structure and or component. Please note, for my Patent the preferred material is carbon fibre.

All internal structures are the diameter of their corresponding structure or component unless where the internal structure has been partly cutaway so as to allow a secondary structure to be joined to the original structure; the cutaways are as shown in Pages 1/16 to Page 14/16. Page 12/16, FIG. 15a, no. 13, the cutaway is shown in isolation. Page 13/16, no cutaways are shown, Page 3/16 FIG. 3, no. 18, Page 9/16, FIG. 13, no. 52 shows the cutaway to allow the Section FIG. 3b, Page 14/16, to move into FIG. 3a, Page 14/16, this can also be seen clearly in Page 15/16 FIG. 18, no. 81, the cutaway on the horizontal buttress and as shown clearly on Page 14/16, FIG. 17, no. 74a showing the horizontal buttress cutaway in clear detail, within section FIG. 3b, allowing section FIG. 3a to move into the section FIG. 3b as shown in Page 14/16, no. 73 and as shown in Page 15/16, FIG. 18, buttress no. 81 of section FIG. 3a can be seen within section FIG. 3b, where FIG. 3a is shown connected to FIG. 3b.

Page 9/16, FIG. 13, no. 51 shows the cutaway to allow the vertical structures Page 15/16 FIG. 18, no. 81 to travel through as shown in FIG. 18, no. 79.

Page 9/16, FIG. 13, no. 47, shows the horizontal internal structure (buttress) such as Page 11/16, FIG. 14, no. 56 and no. 58, which shows the internal buttress or sub structure in the vertical position connected to a structure no. 58 where no. 58 shows how they fit seamlessly to the internal structures or the buttresses forming a cross section by both the vertical buttress and the horizontal buttress that are interconnected to traverse the length of the structures FIG. 3a and FIG. 3b, it can be seen that vertical inner buttresses of FIG. 3a has traversed an arbitrary length of inner FIG. 3b, final length will be defined by the required structural requirements of the final structure and or component, this can be seen in Page 11/16, FIG. 14, section FIG. 3a, no. 56, where no. 56 can be seen by both the unbroken line and broken line traversing an arbitrary length of FIG. 14, section FIG. 3b, no. 58, the vertical buttress of section FIG. 3b; the two buttress of section FIG. 3a and FIG. 3b can be fixed or bonded by suitable methodology.

Page 9/16, FIG. 13, no. 46, shows the internal structure of FIG. 14, Page 11/16; the horizontal buttress as seen on Page 11/16, no. 58b and on no. 45 Page 9/16, FIG. 13, for example is shown as to be placed in the center, this is only for illustrative purposes and can be “offset” to design specifications, such as for a floor pan of an aircraft, where the structure needs to be offset from the central position as shown in FIG. 13 no. 47 (the central position), by broken lines.

Page 9/16, FIG. 13, section FIG. 3a, buttress no. 45, overlaps (not to scale) with the internal structure or buttress of the structure and or component of section FIG. 3b FIG. 13, no. 47; section FIG. 3b not shown here, but (section FIG. 3b) as shown in Page 11/16, FIG. 14, no. 58, so as to bond (by external fixings or glue) to a second such structures and component like that of shown in FIG. 14, where section FIG. 3a and section FIG. 3b are shown as bonded together by suitable means to form the finished structure and or component (material structure or component is made from is not shown) as shown in Page 12/16, FIG. 15 for example. Please note, dependent on where sections such as Section FIG. 3a and Section FIG. 3b which may be part of the final structure and or component, the positioning of internal structures as shown in Page 14/16 FIG. 17, no. 72 may be above or below Page 14/16, FIG. 17, no. 70, however the functionality of combining (in this case the horizontal buttress) remain the same. Therefore, the position of Page 9/16, FIG. 13, no. 45 ether above Page 9/16, FIG. 13, no 47, or below no. 47 and is purely dependent on final design.

Page 9/16, FIG. 13, no. 48, the broken line internal buttress structure shows not only the structure formed as in Page 3/19, Page 6/16, Page 8/16 to Page 15/16. Page 14/16, FIG. 17 does not show the vertical buttresses as seen Page 3/16 and Pages 9/16 to Pages 15/16. The structure and or component can have the internal structure positioned such that the two structure and or components, (each formed by combining the two separate tools as per Page 1/16, FIG. 1, and FIG. 2 forming one larger structure and or component) these structures or components formed by the said tooling can be combined by their respective internal structures as shown in this Patent. The internal buttresses of one structure and or component can overlap the internal buttresses of a secondary structure or component as can be seen for example in Pages 9/16, FIG. 13 and FIG. 13a, Pages 11/16, FIG. 14, no. 58, Page 14/16. FIG. 17 (please note only the horizontal buttress position is shown in Page 14/16) and Page 15/16, FIG. 18. However, as mentioned in this Patent, the overlap of the internal buttresses, in this case the structure and or component of sections FIG. 3a and FIG. 3b internal buttresses, can be 100% of the structure or components length and extended where need be to interconnect with other sections as shown. Please note the final structure and or component shape is designed as a cylinder for illustrative purposes only, it can be conical or tapered as in turbine blades as such designed to suit the application.

Page 10/16 FIG. 13b, no. 44a, shows that when the two halves of the semi cylinders of the outer tool are Joined together, the weight (or by external pressure not shown) of the two halves will compress the material and therefore cure the material that covers the final structure or component; if the material needs heating, suitable mechanism will be designed to heat the tool, which is not part of this Patent; the process of combining the two halves of the two sections I call Process 1.

Page 10/16 FIG. 13b, no. 44b, this section of the outer tool system that can be moved so as to compress the material that covers the final structure or component in its entirety once the two parts of tool coming together and therefore forming the final structure and or component shown in this Patent. The two separate structures or components formed by each tool sections as seen on Page 1/16, FIG. 1 and FIG. 2, to form one large structure and or component; please note each separate section as per this page and this Patent and section FIG. 3a and section FIG. 3b, will be covered in the required material (where necessary) such as carbon fibre and once the two sections are produced and covered in the desired material, and compressed by the outer tool as seen in Page 10/16 FIG. 13b until the material is cured (if the material needs curing), thus producing the final structure or component. The two finished structures FIG. 3a and FIG. 3b, such as seen on Page 12/16, FIG. 15 for example, can be joined together by their corresponding buttresses and the male section as seen in Page 12/16, FIG. 15, no.63 which is the male section of structure and or component FIG. 3b which enters section FIG. 3a forming a further structural join. It must be noted that the male of section FIG. 3b will have a reamed fit or as close to a reamed fit where technology allows, when it enters into section FIG. 3a to join both sections FIG. 3a and FIG. 3b. The heavy black line shown in Page 12/16, FIG. 15 and FIG. 15a, no. 64 partially shows where the material which covers the final structure and component thus forming the final structure or component which may also be defined as the final product. (the material will cover the whole final structure and or component where required but is not shown in this drawing on Page 12/16). Please note Page 12/16, FIG. 15 shows the final product.

The double headed arrow in Page 10/16, FIG. 13b, no. 44c shows direction of travel of this part of the outer compression tooling seen as no. 44a and no. 44b; please note this outer compression tooling design is for illustrative purposes only, showing how the material surrounding the final structure and or component will be compressed to form the final structure or component by the compression of said material of the structure or component; the same method could be used to combine the two tool sections to form the final structure or component.

Please note, there may be no necessity for the final structure or component to have the outer sleeve/skin, this will dependent purely on the final design of the structure or component.

Page 12/16, FIG. 15a shows a sectional view of the buttress either no. 9 or no. 6, for this sectional view I have used the buttress no. 9, as seen in Page 1/16, FIG. 1. It can be seen that the buttress no. 9 in FIG. 15a, how the buttress once it is covered in suitable material will enter the cutaway section of the outer tool, the cutaway is seen in Page 1/16 FIG. 2, no. 10 and also Page 2/16, FIG. 2 no. 10, prior to the insertion of the buttress, in this case represented by buttress no. 9, into the outer section of the tool.

Please also note, Page 12/16, FIG. 15b, shows frontal view of the cutaway shown (no. 10), the buttress no. 9 and also the Flanges no. 14 and no. 14h, 14h is the moving flange so as to compress the material (as seen on Page 1/16, FIG. 1, no. 24), between the flange and the buttress, (the material can be seen in Page 5/16, FIG. 2a) and explained in this Patent.

The white line as shown in Page 12/16, FIG. 15a, no. 10, where no.10 shows the gap (which can also be seen on Page 1/16, FIG. 2) where the buttress no. 9 enters and is flush with the inner surface of the outer material or sleeve/skin, where as mentioned, the white line is only for illustrative purposes to show where the buttress enters and joins and is bonded by a suitable bonding agent (glue) to the final material described as the external material of the corresponding tool section forming (once both tool sections, as seen for example in FIG. 1 and FIG. 2, are joined together) the final structure or component as seen on Page 12/16, FIG. 15, no. 64.and also where no. 64 for illustrative purposes, shows the edge of the outer material of the final structure and or component.

Please note Page 16/16, FIG. 22 shows how the final outer sleeve/skin shown by FIG. 22, is placed on the final structure or component, other methods may be utilised, for example a tape laying machine.

Page 9/16, FIG. 13a, show the internal structures or buttresses and how they overlap as seen in Page 9/16, FIG. 13, which shows the internal substructure buttress overlapping both in the vertical and horizontal direction, these internal substructures will form a cross section which can run the whole length of the internal structure or component if the design of the structure or component requires it, in this illustration the internal substructure is shown to run the whole length of the final structure and or component with extended section (lip) so as to connect with another structure and or component such as described in this Patent and on Page 11/16, FIG. 14, no. 56 the two internal buttress as per Page 13/16, FIG. 16, no. 66, Page 14/16, FIG. 17, no. 70 (which also shows the overlap of one set of buttresses in the horizontal position) and Page 15/16, FIG. 18, no. 80, shows the vertical buttresses of section FIG. 3a and section FIG. 3b where they are connected by suitable mechanism's such as bonding or bolted (as seen in no. 82 and no. 83) at their interface.

Page 12/16 FIG. 15c, the male section in isolation where no. 63a shows the gap in the male section, the male section is shown in FIG. 15, no. 63, this gap allows the buttresses both horizontal (no. 62,) and vertical (no. 58) to traverse into a secondary structure or component.

Page 11/16. FIG. 14, no. 58 shown in part by the broken Lines with dots, between the broken lines depict part of Horizontal structure as seen in Page 14/16, FIG. 17, no. 70 of section FIG. 3b. Page 11/16, FIG. 14, no. 55 section FIG. 3b, structure or component is connected to FIG. 14, no. 54 section FIG. 3a.

Please note, that Page 11/16, FIG. 14, Page 12/16, FIG. 15, Page 13/16, FIG. 16 (FIG. 16 shows a telescope view, looking down the center of the structure and or component) Page 14/16, FIG. 17 and Page 15/16, FIG. 18, only shows two sections of a structure and or component; FIG. 3a and FIG. 3b, but this can be applicable to multiple sections such as those of a large wind turbine blades but not limited too. The structures are shown transparent to show the internal structures of the structure or components.

Page 11/16, FIG. 14, no. 57 shows the cutaway's that allow the section or buttress as shown in this Patent to fit within the section FIG. 3a, Page 14/16. Page 14/16, FIG. 17, no. 74a. Page 11/16, FIG. 14, no. 52 shows the step connection between the two components as per Page 9/16, FIG. 13, no. 52, and as also shown in Page 10/16, FIG. 13b, no. 52 and Page 11/16, FIG. 14, no.52.

Page 12/16, FIG. 15 shows a 3 D illustration of the finished structure and or component.

Page 12/16, FIG. 15, no. 59, shows the horizontal and the vertical buttress forming a cross section. The overlap of the incoming buttresses of 3a onto 3b (or 3b onto 3a) are not shown to allow clarity in FIG. 15, however the buttress in section 3a and 3b are shown. These overlaps can be seen o Page 11/16 to Page 15/16, FIG. 13, FIG. 14, FIG. 16, FIG. 17 and FIG. 18, apart from Page 10/16, FIG. 13b where only one section of the finished structure and or component is shown. As noted in this Patent that I use the description of section FIG. 3a buttresses overlapping section 3b buttresses, however dependent on design of the final structure, sections FIG. 3b buttresses could overlap the buttress of FIG. 3a,

Page 12/16, FIG. 15, no. 64, the edge of the external material (in this case carbon fibre) depicted by the heavy line, not shown in its entirety, so as to see the internal structures (horizontal and vertical buttresses)

Page 12/16, FIG. 15, no. 62, the horizontal buttress showing in both sections 3a and 3b. As mentioned previously, overlaps are shown in Page 11/16 to Page 15/16, and the following figures FIG. 13, FIG. 14, FIG. 16, FIG. 17 and FIG. 18 and connects with outer structure of the finished component or structure as seen on Page 11/16, FIG. 3a, no. 58b, where for illustrative purposes I have shown the horizontal buttress of Page 1/16, FIG. 1 and FIG. 2 no. 5 which can clearly be seen in the finished product of Page15/16, FIG. 18 buttresses, no. 70 and no. 72 respectively.

Page 12/16, FIG. 15, no. 63 the male section of section FIG. 3b fits into section FIG. 3a (female section), as seen in Page 11/16 to Page 15/16, FIG. 14, FIG. 15, FIG. 16, FIG. 17 and FIG. 18.

Page 12/16, FIG. 15, no. 64 shows the external sleeve/skin or covering of the final structure and or component, the final structure or component being formed by the two sections FIG. 3a and FIG. 3b coming together, forming a larger structure as shown in FIG. 15.

Page 12/16 FIG. 15, shows the external material no. 64, being flush with the buttress shown in the horizontal position as seen in Page 13/16, FIG. 16, no. 67.

Page 12/16, FIG. 15, no. 60 section FIG. 3a, FIG. 15, no. 61 section FIG. 3b part of either one or more sections added to section FIG. 3a or section FIG. 3b so as to connect multiple sections which may be required for components such as large wind turbine blades of circa 120 metres in length but not limited too.

Page 13/16, FIG. 16, no. 66, the component structures, as shown in Page 3/16, Page 6/16, Page 8/16, Page 9/16 to Page 15/16, which includes FIG. 3, FIG. 5, Fig, FIG. 13, FIG. 14, FIG. 15, FIG. 17 and FIG. 18. However, Page 13/16, FIG. 16, is showing a view looking directly down the component where the buttresses are shown in the vertical and horizontal position and where on Page 9/16, FIG. 13a the internal structure of the buttresses are shown in isolation so as to have a clearer picture of how the inner structures may overlap each others horizontal structure is shown, as in Page 13/16, FIG. 16.

Page 13/16, FIG. 16, shows internal structures. The sub structures or buttresses (shown in the vertical position) shown in FIG. 16, no. 69, can be one or two or three or more dependent on the final design and structural requirements of the final structure and or component. The sub structures or buttresses are depicted in Pages 1/16 to Page 15/16, (Page 14/16, where only the horizontal buttresses are shown). Page 13/16, FIG. 16 the vertical substructures or buttresses are shown on either side of the horizontal substructure or buttress. Page 9/16, FIG. 13, the vertical substructure or buttress are shown as in part by dotted lines, no. 46, no. 47 and no.48.

Page 15/16, FIG. 18, no. 81 the vertical substructure or buttress of section FIG. 3a, overlapping the vertical substructure of section FIG. 3b, no. 75,

Page 15/16, FIG. 18, shows just one vertical substructure or buttress on the upper side of the horizontal substructure, the lower vertical substructure or buttress not shown.

Please note Page 13/16, FIG. 16, no. 67, shows where the surface of the internal substructure buttress meets and is level (flush) with the external structure of the final structure or component prior to the final structure or component being covered by the outer material or sleeve/skin if a sleeve/skin is required.

Please note Page 13/16, FIG. 16, no. 68, shows where the two sections of the structure and or component are placed one inside the other for an arbitrary length which is the result of design of the both tool sections as shown in Page 7/16, FIG. 7 and FIG. 8, (even though the shape of the tool is shown in Page 7/16 as a square) and as shown in Page 14/16, FIG. 17, no. 70, and no. 71. The length of penetration into the secondary component as in Page 11/16 to Page 15/16 (except Page 13/16), the Page 11/16 to Page 15/16 shows FIG. 14, no. 56, no. 58, FIG. 15, no. 59, no. 62, no. 63, FIG. 16, no. 66, no. 69 FIG. 17, no 70, no. 72 and FIG. 18, no. 77, no. 78, no. 80 and no. 81 will be dependent on final design requirements as will all other sub structures and superstructures. Please note, as mentioned earlier in this Patent, the overlaps are not shown in Page 12/16, FIGS. 15 and 15b of the structures.

Page 14/16, FIG. 17, no. 74a shows the cutaways.

Page 14/16, FIG. 17, no. 70, lower cutaway not shown, as shown in Page 9/16 FIG. 13, no. 52.

Page 14/16, FIG. 17, no. 74 shows the section of Page 14/16, FIG. 17, FIG. 3b. No. 72 section FIG. 3a fits within and over section FIG. 3b, no. 70; the horizontal buttress no.72 fits over the horizontal buttress of no. 70 but can also fit below the horizontal no. 70 if necessary.

Page 14/16, FIG. 17 shows how the two sections of the structure and or component (FIG. 3a and FIG. 3b) fit together, this can also be seen in Page 11/16 to Page 15/16; FIG. 14, FIG. 16 and FIG. 18. The internal horizontal structure or buttress on Page 14/16, FIG. 17, no. 70 and no. 72 shows the overlap of these horizontal buttresses (no. 70 and no. 72) and how they are joined, the substructure or buttress that can be in the vertical position also as seen in this Patent. Page 14/16, FIG. 17, no. 71 shows the internal structure of section FIG. 3b of FIG. 17, where the male section fits within the female section of FIG. 3a. Section FIG. 3b shows only a sectional slice of the sections on how the two sections of the final structure and or component fit together, see also Page11/16, FIG. 14, Page 12/16, FIG. 15 (FIG. 15 does not show the overlaps of the buttress of 3a onto 3b or visa versa), Page 13/16, FIG. 16, Page 14/16, FIG. 17, Page 15/16, FIG. 18.

Page 15/16, FIG. 18, no. 80 buttresses or substructure (shown in the vertical position) in section FIG. 3b overlapping each other, i.e. the buttress of section FIG. 3b overlap the buttress or substructure of FIG. 18, Page 15/16, no. 81 of section FIG. 3a,

Page 15/16, FIG. 18, no. 76, shows in part the depth of penetration of the buttress of section FIG. 3a within sections FIG. 3b of the substructures or vertical buttresses of section FIG. 3a, no. 81 and the depth of overlap of the buttress no. 75 of section FIG. 3b.

Page 15/16, FIG. 18, no. 79 shows the cutaway to allow the vertical buttress or substructure of Page 15/16, FIG. 18, no. 81, of section FIG. 3a to move through buttress (in the horizontal position) or substructure as seen clearly in Page 9/16, FIG. 3a, no. 51, showing the cutaways, of no. FIG. 18, no. 79, also seen clearly in Page 14/16 FIG. 17, no. 74a and on Page 11/16, FIG. 14, no. 57 section FIG. 3b. Lower vertical beam or substructure of section FIG. 3a and FIG. 3b not shown.

The sections Page 15/16, FIG. 18, no. 77 shows the overlap and the penetration of no. 80 of section FIG. 3a into section FIG. 3b, overlapping no. 75 and joining of the buttress or sub structures of section FIG. 3a and FIG. 3b (shown in this case in the vertical position) the sections are also shown in Page 9/16, FIG. 13, no. 48, Page 11/16 FIG. 14, no. 56 and no. FIG. 3b, no. 58, Page 12/16, FIG. 15, no. 59 (overlap is not shown), Page 13/16, FIG. 16, no. 69 and Page 15/16, FIG. 18, no. 80.

Page 15/16, FIG. 18 no. 78 shows how the sections FIG. 3a and section FIG. 3b fit together and show part of the female section accommodating the male section (the rest of the internal female section of FIG. 18, FIG. 3a not shown). This section is also shown in Page 12/16 to Page 14/16; FIG. 15, no. 63, FIG. 16, no. 68 and FIG. 17, no. 71.

Page 15/16, FIG. 18 no. 82 the buttress or substructure (shown in the vertical position) show the bolts connecting buttress or substructure of sections FIG. 3a and section FIG. 3b. Bolt distribution and numbers are for illustrative purposes only and will be confirmed on final design and necessary requirements regarding structural integrity.

Page 15/16, FIG. 18, no. 83 shows the buttress or substructures (shown in the horizontal position), bolts. distribution and numbers of these bolts are for illustrative purposes only and will be confirmed on final design and necessary requirements regarding structural integrity.

Page 15/16, FIG. 18, no. 81 the buttress or substructure of section FIG. 3a, which can run the whole length of the substructure and or buttress of FIG. 18, FIG. 3b, no. 75, but is only shown as running the partial length of buttress no. 75. FIG. 18, no. 80 shows the two vertical buttresses of section FIG. 3a and vertical buttress section FIG. 3b and how they overlap along the arbitrary length. The length of the buttress FIG. 3a, no. 81 will be dependent on final design specification.

Page 15/16. FIG. 18, no. 84a shows the horizontal buttresses of section FIG. 3a and the horizontal buttress of section FIG. 3b overlap to an arbitrary length.

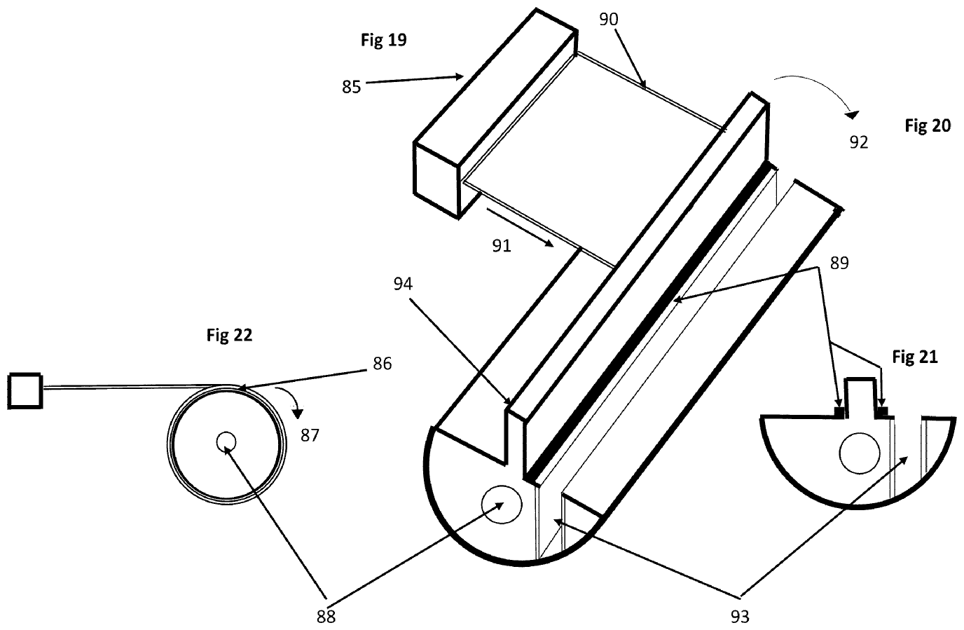

Page 16/16 FIG. 19, no. 85 shows a weaving machine producing either 2D or 3D weave material or can be replaced by a specialist “Carbon fibre Tape winding machine” which would wind carbon fibre around the tool and final structure and or component. In the case of 3D material (in this case carbon fibre material), the woven material is net shaped so that it can follow the shape of the tool, the double lines of no. 90 depicts the woven material. The weaving machine is for illustrative purposes only and does not form part of this Patent.

Page 16/16, FIG. 22, no. 86 shows the 2 D end view of Page 12/16, FIG. 15 as an example of a component produced and a final weave as it (the woven material) is wrapped around the whole structure or component, FIG. 22, no. 87 shows the direction of travel of the material which will cover the final structure or component shown in Page 12/16, FIG. 15 as an example.

FIG. 20, no. 92 shows the direction of travel of the tool half, it must be noted that the tool rotation has to be synchronized with the rotation and speed of release of the material from the weaving machine or tape machine, in the case of the weaving machine, the weaving machine is producing material as a net shape of the tool.

Please note, It may not be essential for the tool to rotate because the more sophisticated tape laying machines can rotate around the tool.

Page 16/16, no 88 shows the central axis of rotations of the material and of the final structure or component or each individual tool section (final structure or component shown in FIG. 22, individual tool section shown in FIG. 20 and FIG. 21). In FIG. 20 and FIG. 21, shows half of the tool as seen in this Patent and in particular Page1/16, FIG. 1 and or FIG. 2, prior to the tool being combined to form the final structure and or component, the final structure or component can be seen in Page 3/16, Page 6/16, Page 8/16 and Pages 9/16 to Pages 15/16, Page 13/16 (telescope view, i.e. looking directly down the structure and or component)

The same method of placing the material on the tool or on the final structure or component can be utilised for a square or oblong or other shapes, however other methods may be utilised if required.

Page 16/16, FIG. 21, no. 89 shows the clamps to hold the material in place and provide tension on either side of the buttress of the tool (the buttress of the tool can be seen on Page 1/16, FIG. 1 no 9 and also Page 1/16, FIG. 2, no. 6). Please note that the drawing showing the buttress of the tool on Page 16/16, no 94, does not indicate whether it is Page 1/16 FIG. 1 no. 9 or FIG. 2, no. 6. It simply indicates the buttress and how the material is placed around each section of the tool, whether it is either one half of the tool or the other half of the tool.

Page 16/16, FIG. 19, no. 90 shows the material from weave machine and or tape machine, no. 91 shows the direction of travel of material..

It must be noted that the weaving machine weaves the material at the same rate as the rotation of the tool, so that the material covers the tool as the tool rotates, ensuring tension on the material at all times if the weaving machine is not wide enough to cover the whole length of the tool, therefore the weaving machine has to weave in sections along the length of the tool, ensuring that the weave is continuous along the tool length and there are no breaks between each section.

However as mentioned previously, a tape laying material may be utilised to place the carbon fibre tape (carbon fibre being the preferred material) and if this is the case, the tool may not be required to rotate.

Page 16/16, no 93 shows the Flanges that will accommodate the incoming buttress from the incoming tool sections as shown in this Patent and clearly in Pages 1/16, Page 2/16, Page 4/16, Page 5/16, Page 7/16 no 14/14h and no. 15 and also shown on Page 12/16, FIG. 15a. showing the flanges in 3 D.

This invention addresses and overcomes the problems in relation to the mass production of large structures by way of a specialist tool design that can be used to produce the components for structures such as large wind turbine blades but not limited too. Currently these types of structures are produced in one long section and produced in most part by hand processes that have limited accuracy as far as accurate material placing and are time consuming, laborious, and costly processes that may result in possible localised stress points which may result in catastrophic failure of the finish components. This form of production does not leave itself to automation to any great degree and in doing so the number of large structures that can be produced on one site is very limited. This invention described the tool that is the fundamental to producing the final structure and or components that rely on structures and or components made from composite materials such as carbon fibre composites, carbon fibre, my preferred material regarding this Patent

My invention by way of specialised tool design enables these large components/structures to be produced in a one shot process or as near to; by this I mean that once the tool has been covered in the desired material, which can again be undertaken in an automated process, as shown, the two sections of the tool can be combined to form the component, the combining of the tool sections can also be undertaken by a suitable mechanism which is not part of this Patent, again this can be fully automated. Therefore, the whole process can be fully automated thus overcoming the many inaccuracies that are associated with a hand process with the additional advantages of lower cost of production, shorter production times and large production volumes, resulting in lower final sales price which will eventually lead to lower cost of power to the consumer (taking turbine blades as an example). The tool design as mentioned in Claim 1 and as shown in the patent drawings can also be utilised for other large structures such as aircraft fuselage and trains front cones, bogeys etc., housing, hotels, hospitals, bridges but not limited too.

The tool innovative design allows the component to be built in sections (if so desired) and connected together in an innovative manner as explained in this patent application, overcoming many of the issues with regard to transportation of said large structure and or components and placing in situ offshore in reference to wind turbine blades (if they are to be placed offshore), dispensing for the need of specialist sea going vessels that are utilised for the placing of the turbine blades onto the generator mechanisms and the major cost associated with this process.

The design of the tooling also shows how large structures such as housing, hospitals, warehouses can be built rapidly and shipped anywhere in the world; in the case of disaster areas they can be built and shipped in hours, provided the tooling is pre-made, the tooling can be made and kept for scenarios such as these and can also be utilised to build very low cost housing wherever the need may be required. It could overcome the issues of housing shortages in the UK where there is a fundamental and growing requirement for rapid low cost housing. A structure can be built and kitted out in a day, like a large production line and then shipped or transported by road or airlifted. If the completed structures height is such that it is too great to transport by road or rail or air, they can be produced near a deep water port docks and placed directly on container ships.

In addition to forming large structures as can be seen in in this Patent, the design within this Patent can also be used to create a mould and with a few modifications as described in this Patent, huge structures such as Caissons can be produced rapidly, with greater structural integrity and longevity and at lower cost than current production methods that are time consuming, slow due to the steel structural component of these structures, having to be produced at great cost. Building these structures take a great deal of time and in doing so projects are vastly delayed and can take years to complete, because without the structures being in place, the remaining frame/surface that sits on the foundation formed by the caissons can not be built and this impacts on the building of further structures such as housing warehousing or airports or indeed sea port on the reclaimed land in most cases, reclaimed from the sea.

### To Conclude

The description of the innovative mechanisms and systems above, minimize, if not eradicate, real difficulties of manufacturing large structures and if necessary, joining these large structures to form an even larger structure such as that of a large wind turbine blade or fuselage of an aircraft or indeed rolling stock such as train front nose and bogeys and livable and working structures such housing, warehouses, hospitals and skyscrapers but not limited too.

In joining of large structures or components by way of sections, the difficulties lay in the structural integrity of the components at these joins, where localised stress points may occur at the join of these large structures or components (I mention large structures or components but the principle as shown in this Patent applies to smaller structures or components). This is overcome by the fact the design of the substructure within this patent is such that when the sections are joined (connected) there are no localised stress points, due to the fact that there are large internal “Superstructures” designed as a cross section formed by the substructures if required (or as a single horizontal substructure) that can run internally the whole length of the component such as a large wind turbine blade for example, and therefore removing any localised stress points. The overlaps of each of the vertical substructures and horizontal sub structures forming an internal Superstructure to that of which it is connected too, such as shown in this Patent removes any such localised stress points.

The substructure or the superstructure can be as long or short in length as required by structural design; this structure as mentioned above, eliminates any “localised” stress points and therefore the external “sleeve/skin” or cover does not have to be a structural part of the whole component structure and only needs to serve as an external skin.

As mentioned in this patent, the component is supported by the internal cross section sub structure and in addition this internal substructure is further supported structurally by the fact that one section can be placed inside the other section forming an internal superstructure that spans both parts of the tool. The amount of travel of the length of the female section by the male section of the two structures will be dependent on the final structural integrity requirements of the structure or component and therefore the structure and or component tool design will take this into account.

As mentioned in this Patent there may be a requirement for the final structure or component not to have a “vertical” structure and or buttress above and or below the horizontal structure and or buttress or only one vertical substructure or buttress dependent on final structural and design requirement of the finished structure or component.

The current methodology especially in wind turbine blades is to produce these structure as one large section.

However, there are many issues arising regarding the production of these large structures, these issue are well documented. To this end, I shall name but a few such as; considerable amount of man hours to produce these structures, for example structures such as wind turbine blades where the process in most part are labour intensive, taking significant amount of time resulting in substantial production cost therefore comparable to an automated or semi-automated process, is non cost effective. In addition to the above, the process of hand layup of material forming the composite structure can contain inaccuracies in material deposition resulting in localised stress points that may result in structural failure of the component. To further the difficulties in production, internal superstructures have to be placed within the blade as secondary processes and in doing so add to the cost of the blade production and again add to the possibilities of these structures failing due to the fact that they are secondary processes; if the internal structural components fail then the whole component will fail.

The above are but a few of the many issues that have to be overcome in designing and producing large structures at a competitive cost to achieve market penetration and reduce final sales price.

For wind turbine blades (taking these structures for example), there are also substantial additional cost of transportation of these large structures that can be over 100 m in length and also placing these structures in situ where there are only a few ocean going vessels that have the technology and capabilities to undertake such a task, again increasing the cost of the total blade.

It is understood that much time and research and investment has been placed to develop the production of these large structures and the expertise of the companies involved are world leading, however the processes are still based on mainly non automated systems of production and as such, the cost and time and indeed the structural integrity of the components may result in very large structures not being viable economically in the near to medium term and long term future.

I believe that my Patent overcomes many of the above issues by producing sections or large structures in a “one shot” process with regard to the internal superstructures and external structures, where there are no secondary processes apart from joining the two halves of the tool and this can be done in a fully automated process by utilising external mechanism to combine the two halves of the tool. To produce the components, the composite material has to be wrapped around the tool halves as shown in this Patent, prior to combining the halves of the tool, again this can be undertaken in a semi or fully automated process and there are a number of technologies that can undertake this process that are currently on the market. I have mentioned the technology that I prefer in this Patent, but it is not limited to this technology and therefore other viable technologies may well be utilised, that are available on the market if required to combine the two halves of the tool to form the final structure or component.

In addition, all materials thicknesses and material structure can be designed to suit the component structural requirements and can be placed in situ by way of an automated process as shown in this patent and in doing eliminates the issues regarding placing the material by hand to produce said structure or component, thereby eliminating the problems with the composite structure or component material deposition inaccuracies.

Another major cost savings is that by producing these components in 25 metre length plus sections (or less), resulting in ease of transportation, major cost savings associated with this and additional cost savings with regard to placing these blades (if the final component is a blade for off shore wind) in situ, where specialist sea going vessels are no longer required.

This form of structure can be extremely robust for joining together two or more sections of large structures such as wind turbine blades, fuselage of aircraft, nose cones of trains etc. but not limited to where the internal structure can act as a superstructure for any of the above structures and in addition, manufactured in one step.

This process allows structures with a high inherent strength to be produced more efficiently and at a lower cost than known methods. This is especially advantageous in situations where the structure has to be built quickly such as in situations of natural disasters (e.g. earthquakes, storms, flooding etc.), military scenarios, or for further example, during pandemics when medical buildings are required at short notice.

The methods and embodiments described here are not restricted to the above implementations. Modifications and additions could be made to the tool and the methodologies e.g. by addition of apparatus and extra steps to improve its specific usability. In particular, the invention and its embodiments can be usefully deployed or enhanced using the most advance technology by way of material weaving and utilising the advanced 3 D weave technology that is currently available where the 3 D weave technology can combine various material to provide the optimum structural integrity with minimal cost related to material design..

1. a tooling design that allow large structures or small structures or components to be produced in a possible singular (One Stop) automated process where secondary processes are limited or reduced to a minimum or eradicated altogether and where automated processes can be utilised so as to reduce the inaccuracies associated with manual production and in turn reduce the cost and time taken of said production where a tooling structure formed by way of two halves of said tooling structure and where these two individual halves of the tool are to be covered in suitable material such as carbon fibre (by a suitable methodology) such as a 3 D carbon fibre weave, but not limited too, that is net shaped (3D weave) and fed onto the tool by way of each individual half of the tool revolving on its central axis of rotation (if required) to be in synchronization with the incoming material fed by the weaving machine or tape winding machine thus completely covering the tool section as required and where necessary, other methods may be deployed to cover the tool with required material as required to form the final required structure and or component using buttresses that move within a set of flanges that are part of each tool half when placed together (by suitable automated means or semi automated or manual) form the final tool and internal substructure, where the horizontal buttress overlap the horizontal buttress of the incoming opposing tool and where the vertical buttresses of each tool enters the flanges of the corresponding tool thus forming an internal superstructure by the buttresses and flanges of the tool, in the shape of a cross, whose length within the final structure or component is purely dependant on the structural requirements of the final structure and or component and who's width is the width of the internal diameter of the tool and final structure or component (where it needs to be the internal diameter), this superstructure is designed to enable the required strength, stiffness (in the case of turbine blades and aircrafts structures as an example but not limited too) and stability to the whole final structure and or component produced by the tool to form the body of the final structures or component and in addition these internal structures can be designed within the final structure or component to be extended beyond the parameters of the original structure or component so that these internal structures or superstructures can interconnect with a secondary finished structure or component both in the vertical direction and in the horizontal direction so that multiple completed structures can be connected together if required so as to form large structures such as wind turbine blades or aircraft fuselage or housing but not limited too and for example caisson construction (as a mould for concrete), building construction, trains, aircrafts structures and components, automotive parts and automotive body construction, but not limited too, once the tooling has been removed by suitable means leaving behind the final structure and or component as described in the above and in this Patent, as for example the production of caissons, where the final structure that is formed by tooling will form the mould which forms the caisson, it may be noted that in some final structures or components there may only be a need for one or more vertical buttresses or no vertical buttresses if the final structure or component design may require this to be the case and where the structural integrity or otherwise allows for more than one vertical buttress or indeed no vertical buttresses

2. as according to claim 1, the vertical buttresses of each tool section are offset against each other so as to allow the two internal vertical buttress to come together by entering the flanges of the respective tool sections, thus forming the final tool

3. as according to claim 1, the final structures or components that are produced by the two independent tools which are joined together by suitable means to form a final structure and or component by the removal of the tool (that is formed by the coming together of the two individual halves of the tool), once the material is cured, if the material needs curing (the material in this case being carbon fibre the preferred material for this patent but not limited too) forming one structure and or component

4. as according to claim 1, the vertical buttresses (by this I mean the vertical buttress above and or below the horizontal buttress) of the finished structure or component, these buttresses whether vertical or horizontal will be offset against the vertical and or horizontal buttresses of any secondary completed structure or component, so as to allow the internals vertical and/or horizontal buttresses of each finished structure or component when fitted to another completed structure or component, thus allowing the buttresses of these structures or components to run parallel to each other so as to allow these internal buttress (of the two or more structures or components) to interconnect and therefore joining such secondary or multiple structures and or components seamlessly with suitable connections such as bolts or bonding

5. as according to claim 1, the internal horizontal buttress and the vertical internal buttress of one completed structure or component to interconnect with a second completed structure or component means that the internal horizontal buttress and the internal vertical buttress can be overlapping to form a strong join that can run the whole length (if required to run the whole length) of the two internal structures of the two independent structures and or components, this internal structure formed by the cross section of the horizontal and vertical buttresses is the internal superstructure that becomes an integral structural part of both structures or components that have been joined in this manner

6. as according to claim 1, the Patent also shows how the finished structure with slight modifications can be used as a mould for large structures as described, except for the fact that the mould remains in situ acting as an integral part of the structure contributing to the structural strength and integrity of the structure that is created by the mould, thus creating large structures rapidly and at low cost

7. as according to claim 1, that each horizontal buttress of the respective tool where when two halves of the tool are joined together run parallel to each other forming an airtight fit so as to compress the material between the respective horizontal buttress of each tool once the tool sections are joined together to form the final structure or component on the tool removal

8. as according to claim 1, the internal structures or buttress, is covered in material as is all surfaces of each individual tool (apart from where indicated the individual tools are not to be covered) and this material covering the buttresses form the internal superstructure of the final structure and or components' and by these internal superstructure of the final structure or components are formed by removal of the tool once the material has been cured If the material requires curing

9. as according to claim 1, by the combining of the two tooling structures when combined also form a horizontal internal buttress structure whose material that forms this internal structure is double the thickness of the material that covers the vertical buttresses of the structure or component

10. as according to claim 1, one of the Flanges which is part of the horizontal buttress in each tool is designed to move in a parallel direction towards the other Flange within this tool section so as to compress the material that is covering the vertical buttress that enters between the Flanges so as to form the final structure or component produced by the tool

11. as according to claim 1, if the final structure produced by the tool is that of an aircraft fuselage for example, there will be a requirement for the horizontal buttress which will form the floor pan of the aircraft and a requirement for only one internal “lower” vertical buttress and the “upper” vertical buttress on the opposite surface of the horizontal buttress will not be required and this lower vertical buttress can be cutaway as required, so as to accommodate the internal requirements (without losing structural integrity) of the aircraft such as electronics, undercarriage, cargo, but not limited too

12. as according to claim 1, the internal horizontal buttress structure of one completed structure and or component can interconnect with a second completed structure or component means that the internal horizontal buttresses or structures can be overlapping where their corresponding surfaces form an air tight fit allowing a strong join of these surfaces that can run the length of the two internal structures if required, and where the two horizontal structures can be joined together and therefore joining the two structures or components seamlessly by way of suitable connections such as bolts or bonding

13. as according to claim 1, the internal vertical buttress structure of one completed structure or component can be interconnect with a second completed structure or component means that the internal buttresses can be overlapping where their corresponding surfaces form an air tight fit allowing a strong join of these surfaces that can run the length of the two internal structures if required, and where also the two vertical buttress structures of each structure or component can be joined together and therefore joining the two structures or components seamlessly by way of suitable connections such as bolts or bonding

14. as according to claim 1, to allow the vertical and horizontal buttress structures, to overlap respectively with the secondary completed structure or component, the tool has been designed where the final structure or component formed by the tool where the tool accommodates an extension or “lip” of both the horizontal and vertical buttresses to allow the creation of an overlap of the vertical and horizontal structures in the final structure or component

15. as according to claim 1, there can be a number of vertical internal buttresses designed into the tool

16. as according to claim 1, there may be only one horizontal buttress designed into the tool but others can be incorporated into the finished structure or component by way of dividers

17. as according to claim 1, when each of the two halves of the tool come together by suitable means they form a whole tool where once the tool is removed will form the final structure or component

18. as according to claim 1, the tool design incorporates a step, forming a male section so that one structure and or component can fit within a secondary structure or component forming a reamed fit between the two structures or components, the length or distance one “male” section of the structure or component enters and traverses the “female” section of the other structure or component is dependent on the length of the male section and dependent on the required structural integrity of the join

19. as according to claim 1, the join of two or more completed structures or components will be a smooth and perfect fit so the external material or sleeve/skin will flow seamlessly from one structure or component to the other if there is a requirement for an external sleeve/skin

20. as according to claim 1, the final structure or component can incorporate carbon fibre composite poles or suitable material to act as a reinforcement for the concrete structure formed by the mould, for structures such a Caissons but not limited too

21. as according to claim 1, the structure for the mould can have a fabric but not limited to, that can be placed around the mould neck so that when concrete is poured inside the mould when the mould is off-shore and in situ, the concrete does not overspill into the sea or other water surfaces but not limited too

22. as according to claim 20, the structure or component can act as mould for large structure such as caissons and in doing so carbon fibre poles/rods (for example) can be placed in the mould forming a grid section that can act as structural reinforcement for the material (in this case concrete)

23. as according to claim 5, the internal cross section formed by both the horizontal buttress and the vertical buttress known as the “superstructure” (assuming that there are two vertical buttress, there may be, due to design requirement, only requirement of one vertical buttress or none) can run the whole length of the internal final structure and or component and can extend beyond the boundaries of the main structure and component if design of final structure or component require

24. as according to claim 16, dividers can be placed within the final structure or component to increase the number of horizontal buttresses to the full depth of the said structure or component crossing both the vertical and horizontal buttress to allow material to be poured into the finished structure (in this case concrete but not limited too), so that the dividers form a 3 D grid honeycomb system, therefore creating a substantial number of columns of concrete, the number and the dimensions of the “pillars” which will be dependent on the size of the final mould and the structural requirements of the final large structure

25. according to claim 24, dividers can be placed within the final structure or components, in this case if they are large structures such as houses, warehouses, hospitals, and any other such large structures, dividers can be utilised to form rooms or separate small or large spaces where required for human habitation, or otherwise

26. as according to claim 13, multiple structure or components can be joined together forming large structures such as wind turbine blades, fuselage for aircrafts, boat hulls, but not limited too where in the case of building structures, the structure or component can be joined in both the vertical and horizontal direction or degrees of the vertical or horizontal direction
